(19) United States
(12) Patent Application Publication
(10) Pub. No.: US 2012/0166257 A1
(43) Pub. Date: Jun. 28, 2012

(54) EXERCISE MANAGEMENT APPARATUS, EXERCISE MANAGEMENT METHOD, AND RECORDING MEDIUM

(75) Inventors: Minoru SHIRAGAMI, Kswasaki (JP); Shoji Naito, Osaka (JP)

(73) Assignee: Fujitsu Limited, Kawasaki-shi (JP)

(21) Appl. No.: 13/331,547

(22) Filed: Dec. 20, 2011

(30) Foreign Application Priority Data
Dec. 27, 2010 (JP) 2010-289783

(51) Int. Cl. G06Q 30/02

(52) U.S. Cl. 705/14.1; 705/26.1; 705/26.7

(57) ABSTRACT

An exercise management apparatus includes, a storage unit that stores information that identifies an item selected by a user and a target level of an amount of exercise determined by the user, a determination unit that receives the amount of exercise measured according to exercise by the user and determining whether the received amount of exercise has reached the target level stored in the storage unit, and a notification unit that transmits notification information including information about the item stored in the storage unit to the user through a network when the determination unit determines that the received amount of exercise has reached the target level.

### CROSS-REFERENCE TO RELATED APPLICATIONS

This application is based upon and claims the benefit of priority of the prior Japanese Patent Application No. 2010-289783, filed on Dec. 27, 2010, the entire contents of which are incorporated herein by reference.

### FIELD

The present embodiment relates to an exercise management apparatus, an exercise management method, and a recording medium.

### BACKGROUND

Electronic commerce (EC) sites for selling commercial items through networks have been widely used with the development of communication technologies, such as the Internet. Users may access EC sites from their terminal devices, select a commercial item, and carry out a purchase procedure to purchase the selected item. In recent years, some EC sites have places called “Wish lists” for temporarily storing information about candidate commercial items which the user wishes to purchase in the future. The user may call out the information about an item of interest stored in the Wish list at any appropriate time and may carry out the purchase procedure for the called out goods.

On the other hand, in recent years, information about a user's health may be transmitted to a server through a network and the user's health may be managed on the server. For example, there is an insurance management server for acquiring measurement data about an insurer's health and, based on the acquired measurement data, reporting the contents of reduction in the efforts for attaining a previously defined behavioral objective.

Furthermore, in recent years, measurement hardware, such as pedometers and scales, with communication functions and cell phones with pedometer functions have been offered commercially. In an exemplary system using measurement hardware having a communication function, a terminal device receives health data measured by the measurement hardware, changes contents displayed on the display of the terminal device in response to the received health data, and a reward-application button is displayed in the contents when the health data has satisfied predetermined conditions. Furthermore, there is a wireless communication apparatus that downloads reward data from a server when the result of detecting the movement of the user has reached a predetermined goal.

### SUMMARY

According to an aspect of the invention, an exercise management apparatus includes, a storage unit that stores information for identifying an item selected by a user and a target level of an amount of exercise determined by the user, a determination unit that receives the amount of exercise measured according to exercise by the user and determining whether the received amount of exercise has reached the target level stored in the storage unit, and a notification unit that transmits notification information including information about the item stored in the storage unit to the user through a network when the determination unit determines that the received amount of exercise has reached the target level.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a computer system of a first embodiment;

FIG. 2 is a diagram illustrating an exemplary configuration of a computer system of a second embodiment;

FIG. 3 is a diagram illustrating an exemplary hardware configuration of an exercise management server;

FIG. 4 is a diagram illustrating an exemplary hardware configuration of a cell phone;

FIG. 5 is a block diagram illustrating a processing function of an EC server and an exercise management server;

FIG. 6 is a diagram illustrating exemplary data stored in an item DB;

FIG. 7 is a diagram illustrating exemplary data stored in a course DB;

FIG. 8 is a diagram illustrating exemplary data stored in a user DB;

FIG. 9 is a diagram illustrating exemplary data stored in an incentive DB;

FIG. 10 is a block diagram illustrating processing functions of a cell phone;

FIG. 11 is a sequence diagram illustrating processing performed among an exercise management server, an EC server, and a cell phone.

FIG. 12 is a diagram illustrating an exemplary window of an item-selection screen;

FIG. 13 is a diagram illustrating an exemplary window of a course-selection screen:

FIG. 14 is a diagram illustrating exemplary contents of an e-mail which notifies goal achievement;

FIG. 15 is a flow chart illustrating processing of an exercise management server when enrollment in an exercise management course is accepted;

FIG. 16 is a flow chart illustrating processing of an exercise management server the amount of exercise is received from a cell phone;

FIG. 17 is a sequence diagram illustrating processing among apparatuses in a computer system according to a third embodiment;

FIG. 18 is a circuit diagram illustrating an exemplary window of an item-selection screen;

FIG. 19 is a diagram illustrating exemplary data stored in a user DB;

FIG. 20 is a diagram illustrating a sequence diagram illustrating processing among apparatuses in a computer system according to a fourth embodiment;

FIG. 21 is a diagram illustrating an exemplary system configuration of a computer system according to a fifth embodiment;

FIG. 22 is a diagram illustrating exemplary data stored in a user DB;

FIG. 23 is a sequence diagram illustrating processing until an exercise management course is started in the fifth embodiment;

FIG. 24 is a flowchart illustrating processing for additional enrollment in an exercise management course by an exercise management server; and

FIG. 25 is a sequence diagrams illustrating processing after the start of the exercise management course in the fifth embodiment.

### DESCRIPTION OF EMBODIMENTS

Hereafter, embodiments will be described with reference to the attached drawings.

### First Embodiment

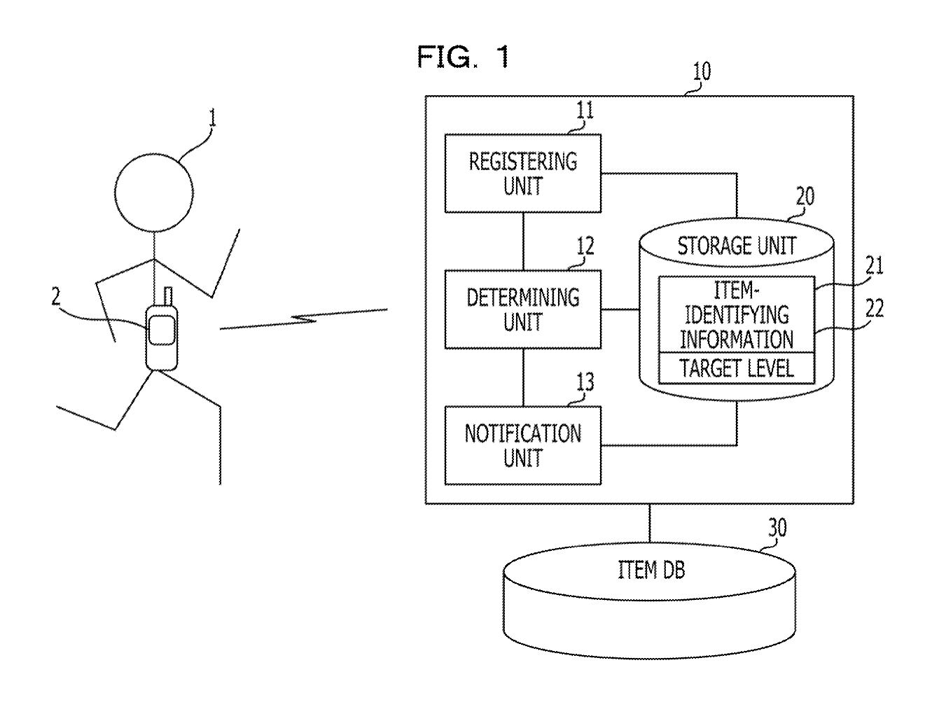

FIG. 1 is a diagram illustrating an exemplary configuration of a first embodiment.

A computer system illustrated in FIG. 1 includes a user terminal device to be operated by a user 1 and an exercise management device 10 that manages the degree of attainment of a predetermined target amount of exercise of the user 1. The amount of exercise of the user 1 is transmitted to the exercise management apparatus 10 through a user terminal device operated by the user 1. In FIG. 1, a mobile terminal device 2 is illustrated as an example of the user terminal device. The mobile terminal device 2 has functions for measuring the amount of exercise of the user 1 and transmits the obtained data to the exercise management apparatus 10 by wireless. Here, for example, the amount of exercise to be transmitted to the exercise management apparatus 10 may be expressed by the number of steps, walking/running rate, or walking/running distance.

The exercise management apparatus 10 includes a registering unit 11, a determining unit 12, a notification unit 13, and a storage unit 20. For example, a central processing unit (CPU) in the exercise management apparatus 10 may execute predetermined programs to realize the processing of the registering unit 11, the determining unit 12, and the notification unit 13. Here, the storage unit 20 may be provided as an external unit of the exercise management apparatus 10.

The registering unit 11 enters, in the storage unit 20, both item-identifying information 21 which identifies a purchase-candidate item selected by the user 1 and a target exercise amount (target level) 22 which is determined by the user 1. The target level 22 is determined by selective operation of the user 1 on the user terminal device. For example, the registering unit 11 displays a selection screen for a purchase-candidate item and an input screen for target level 22 on the mobile terminal device 2. The registering unit 11 receives information which is entered by the user 1 through the selection screen or the input screen and accepts the purchase-candidate item and the target level 22.

Here, for example, the purchase-candidate item may be selected from a plurality of commercial items registered in an item DB (database) 30 which is connected to the outside of the exercise management apparatus 10. The item DB 30 has the registered information about the respective items, such as item-identifying information, brand-name information, and price information. The registering unit 11 acquires the information of a plurality of the items from the item DB 30 and displays a list on the display for a purchase-candidate item to allow the user to select any item as a purchase candidate item from the items displayed on the screen.

The item DB 30 may be one installed in an item-selling server that provides an item-selling service through a network. The item DB 30 may be installed in the exercise management apparatus 10. In addition, the exercise management apparatus 10 itself may have the functions of the item-selling server.

The user terminal device having a function of measuring the amount of exercise, such as the mobile terminal device 2, is not always used to select the purchase-candidate item or determine the target level 22. Alternatively, for example, the selection and the determination may be performed by another user terminal device. The registering unit 11 may not accept the selection of a purchase candidate item directly from the user terminal device. For example, the registering unit 11 may accept the selection of a purchase-candidate item through another device, such as an item-selling server.

The determining unit 12 receives an exercise amount measured in response to the exercise of the user 1 from the user terminal device through the network. Then, the determining unit 12 determines whether the received exercise amount has reached the registered target level 22 stored in a storage section 22. The measured exercise amount (measured level) may be entered into the user terminal device by operation of the user 1 and transmitted to the exercise management apparatus 1. However, a user terminal device with great convenience is one having a function of measuring the amount of exercise as in the case of the mobile terminal device 2 because such a user terminal device is able to transmit the exercise amount measured by the user terminal device itself to the exercise management apparatus 10. The user terminal device having the exercise-amount measuring function may periodically transmit the measured exercise amount to the exercise management apparatus 10.

The notification unit 13 transmits notification information through the network when the determining unit 12 determines that the exercise amount of the user 1 has reached the target level 22. The notification information includes information about a purchase-candidate item corresponding to the item-identifying information 21 registered in the storage unit 20. For example, the notification unit 13 reads the information about the purchase-candidate item corresponding to the item-identifying information 21 registered in the storage unit 20 from the item DB 30 and includes the information in the notification information.

The term “notification information” means information to be notified to the user 1 through the network. For example, the notification information may be transmitted as an e-mail addressed to the e-mail address of the user 1. The information about the purchase-candidate item, which is included in the notification information, may include, for example, brand-name information and price information. When the mobile terminal device 2 receives the notification information, the user 1 can confirm the information about the previously-registered purchase-candidate item by browsing the notification information received by the mobile terminal device 2.

In the processing of the exercise management apparatus 10 described above, when the exercise amount of the user 1 has reached the target level 22, the user 1 is notified of the information about the purchase-candidate item. Therefore, the user 1 may be prevented from forgetting to purchase the purchase-candidate item. Thus, the user 1 may certainly purchase the purchase-candidate item. As the purchase of the item is linked to the exercise, the buying motivation of the user 1 for the purchase-candidate item can be kept during the exercises of the user 1. Also from this point, the user 1 may certainly purchase the purchase-candidate item. Therefore, the sales of commercial items may be promoted.

The notification information may include guide information for guiding the user to an understanding of a procedure for purchasing a purchase-candidate item as information about the purchase-candidate item. In this case, the user 1 who has checked the notification information may easily purchase the purchase-candidate item by performing the purchase procedure for the purchase-candidate item based on the guidance information. Thus, sales of commercial items may be further promoted. As guidance information, for example, webpage-link information provided by the item-selling server may be employed.

### Second Embodiment

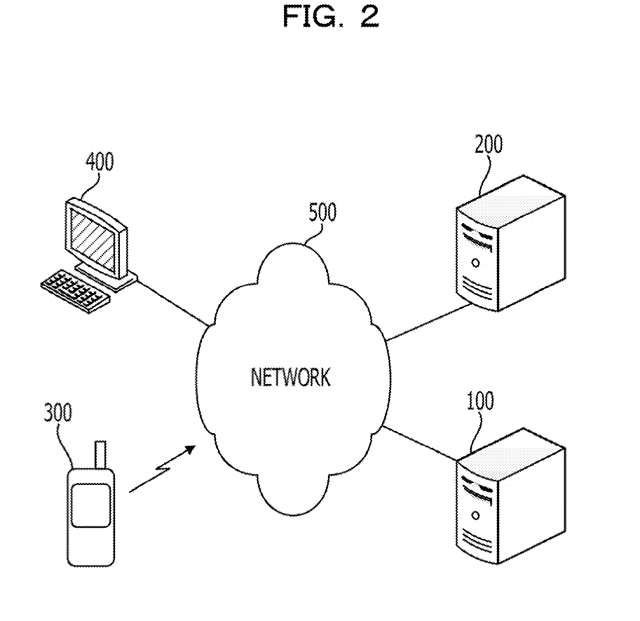

FIG. 2 is a diagram illustrating an exemplary configuration of a second embodiment.

A computer system illustrated in FIG. 2 includes an exercise management server 100, an EC server 200, a cell phone 300, and a PC 400, and these devices are connected to one another through a network 500. The cell phone 300 is connected to the network 500 through the base station (not illustrated) of a wireless telephone network.

The exercise management server 100 provides the exercise management service that manages a user's exercise amount. The exercise management service is a service that manages whether the amount of exercise has reached the target level by making a user set up the target exercise amount for a predetermined period of time and acquiring data of the user's exercise amount from the cell phone 300 or the PC 400 at any time.

The exercise management service allows the user to select a purchase candidate item from a list of commercial items to be sold by the EC server 200 in advance and, when the amount of exercise of the user has reached a target level, notifies the user of information for allowing the user to purchase the purchase-candidate item. The commercial item selected as a purchase candidate is managed in a “reward list” in the exercise management server 100. Commercial items registered in the “reward list” are notified as “reward items” to the user when the user has reached the goal. Thus, the user is allowed to purchase the items. As described above, sales of commercial items are promoted by setting up the goal of the user's exercise and notifying the user of “reward items” when the exercise amount has reached the target value to keep the user's purchase motivation for the purchase-candidate item.

The EC server 200 provides the user with a sales service which sells commercial items through the network 500. The EC server 200 provides the user with an item-list display service, a selective item-reception service, a settlement service, and the like through a Web site. The EC server 200 may also provide the exercise management server 100 with the information about items to be sold.

The cell phone 300 is an exemplary user terminal device to be used by a user who utilizes a service provided by the exercise management server 100 or the EC server 200. The cell phone 300 accesses the Web site provided by the EC server 200 in response to the operation of the user. The user may select a commercial item, which is sold by the EC server 200, offer purchase thereof, and perform payment processing, and so on.

The cell phone 300 accesses, for example, the Web site provided by the exercise management server 100 in response to the user's operation. The user performs a request for registration of a target exercise level, a request for registration of a commercial item in a reward list, or the like on the exercise management server 100 through the Web site displayed on the cell phone 300.

The cell phone 300 has a function of measuring the number of steps, walking distance, walking rate, the amount of activity, or the like. Here, the amount of activity refers to a numerically represented amount of exercise based on the strength and time of physical activity and is represented by the unit of “Ex”. The strength of physical activity means the number of multiples of a reference value which is defined as “1” while the individual sits down quietly and is represented by the unit of “METs”. The cell phone 300 calculates the amount of activity by estimating the walking/running state of the user carrying the cell phone 300 from the number of steps, a walking distance, a walking rate, walk time, or the like.

The cell phone 300 registers a target exercise amount and a reward item in the exercise management server 100 and then periodically transmits the measured exercise amount to the exercise management server 100. Furthermore, when the amount of exercise has reached the target exercise amount, the cell phone 300 receives an e-mail that notifies the user of the attainment of the target exercise amount from the exercise management server 100. The e-mail received by the cell phone 300 describes information that allows the user to purchase the purchase-candidate item. For example, the e-mail describes the uniform resource locator (URL) of a Web page for the purchase procedure for the purchase-candidate item. The user may operate the cell phone 300 and access the URL described in the e-mail to proceed to the purchase procedure for the purchase-candidate item.

The PC 400 is another exemplary user terminal device which may be used by a user who utilizes services provided by the exercise management server 100 and the EC server 200. The user may use the PC 400 instead of the cell phone 300 and may access the Web site provided by the exercise management server 100 and the EC server 200. In contrast to the cell phone 300, the PC 400 does not include the functions of measuring the amount of exercise and transmitting the result of the measurement to the exercise management server 100. Instead, for example, the PC 400 acquires the user's exercise amount measured by external measurement hardware in response to the input operation of the user. Then, the measurement result of the acquired exercise amount may be transmitted to the exercise management server 100.

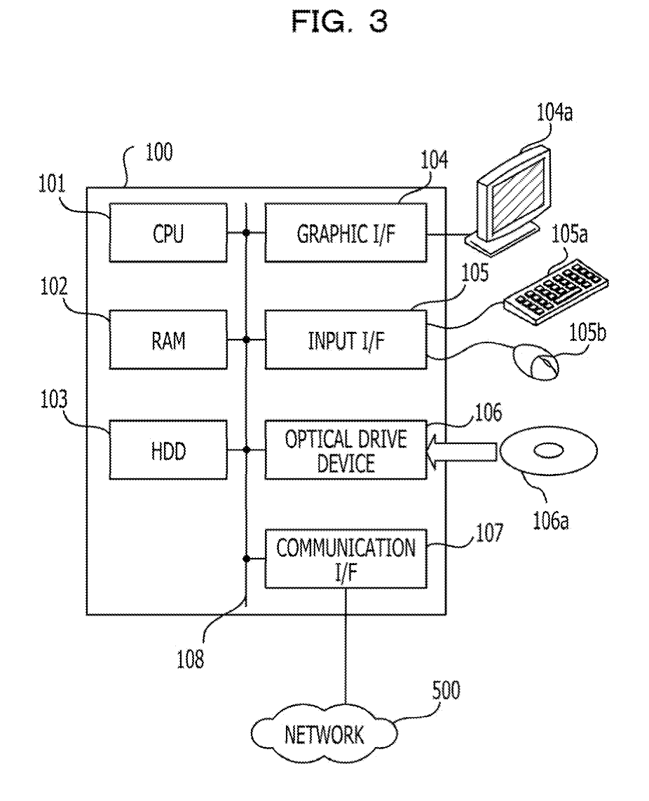

FIG. 3 is a diagram illustrating an exemplary hardware configuration of the exercise management server.

The exercise management server 100 realizes a computer as illustrated in FIG. 3. The computer employs a CPU 101 to control the entire apparatus. The CPU 101 is connected to a random access memory (RAM) 102 and a plurality of peripheral devices through a bus 108.

The RAM 102 is used as a main storage unit of the computer. The RAM 102 temporarily stores an operating-system program (OS) and part of an application program, which are executed by the CPU 101. The RAM 102 stores various kinds of data required for processing with the CPU 101.

Examples of the peripheral devices connected to the bus 108 include a hard disk drive (HDD) 103, a graphic interface (I/F) 104, an input interface (I/F) 105, an optical drive device 106, and a communication interface (I/F) 107.

The HDD 103 magnetically performs writing and reading of data to the built-in magnetic disk. The HDD 103 is used as a secondary storage of the computer. The HDD 103 stores an OS program, an application program, and various kinds of data. Alternatively, a semiconductor storage, such as a flash memory, may be used as a secondary storage device.

The graphic I/F 104 is connected to a display 104a. The graphic I/F 104 displays an image on the display 104a according to a command from the CPU 101. For example, the display 104a may be a liquid crystal display.

A keyboard 105a and a mouse 105b are connected to the input I/F 105. The input I/F 105 transmits output signals from the keyboard 105a and the mouse 105b to the CPU 101. The mouse 105b is only illustrated as an example of a pointing device. Alternatively, other pointing devices may be used. Examples of other pointing devices include a touch panel, a tablet, a touchpad, and a trackball.

The optical drive device 106 reads the data stored in an optical disk 106a using a laser beam or the like. The optical disk 106a is a portable recording medium in which data is stored in a form readable by reflection of light. Examples of the optical disk 106a include a digital versatile disc (DVD), DVD-RAM, a compact disc read only memory (CD-ROM), a compact disc readable/rewritable (CD-R/RW).

The communication I/F 107 is connected to a network 500. The communication I/F 107 performs data transmission/reception with other devices such as the EC server 200 through the network 500.

The EC server 200 and the PC 400 may be realized by the same hardware configurations as those illustrated in FIG. 3, respectively.

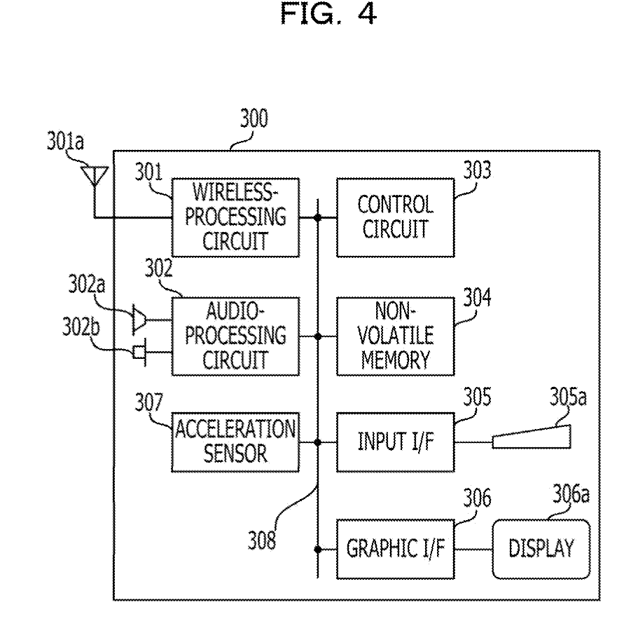

FIG. 4 is a diagram illustrating an exemplary hardware configuration of a cell phone.

The cell phone 300 includes a wireless-processing circuit 301, an audio-processing circuit 302, a control circuit 303, a non-volatile memory 304, an input I/F 305, a graphic I/F 306, and an acceleration sensor 307, and these structural components are connected to one another through a bus 308.

The wireless-processing circuit 301 is connected to an antenna 301a for performing wireless communication between a base station and a wireless telephone line. The wireless-processing circuit 301 performs demodulation of signals received from the antenna 301a, data separation, generation and modulation of data to be transmitted, and so on.

The audio-processing circuit 302 is connected to a speaker 302a and a microphone 302b. When calling, the audio-processing circuit 302 encodes an audio signal collected by the microphone 302b and supplies the audio signal to the wireless-processing circuit 301. Simultaneously, the audio-processing circuit 30 decodes and amplifies the audio signal demodulated from a radio wave received by the wireless-processing circuit 301 and then reproduces and outputs a call voice from the speaker 302a.

The control circuit 303 includes a CPU, a RAM, and the like and performs overall control of the cell phone 300. For example, the control circuit 303 controls telephone-call processing and data-communication processing through the wireless-telephone line, and executes an application program stored in the non-volatile memory 304.

The non-volatile memory 304 stores various kinds of programs to be executed by the control circuit 303, various kinds of data required for the execution of the programs, and so on. The non-volatile memory 304 is realized as a semiconductor memory, such as a flash memory. A non-volatile storage medium, such as an HDD, may be installed instead of the non-volatile memory 304.

The input I/F 305 is connected to an input keypad 305a. The input I/F 305 transmits an output signal from the input keypad 305a to the control circuit 303. The input keypad 305a is only illustrated as an example of an input device. Alternatively, other input devices, such as a touch panel formed on a display 306a, may be used.

The graphic I/F 306 is connected to the display 306a. The display 306a may be, for example, a liquid crystal display or an organic electroluminescence (EL) display. The graphic I/F 306 makes the display 306a display the command from the control circuit 303.

The acceleration sensor 307 measures acceleration in three axial directions and notifies the control circuit 303 of the results of the measurement. As described later, the control circuit 303 executes a predetermined application program to calculate the number of steps, a walking distance, a walking rate, the amount of activity, and the like of the user carrying the cell phone 300 based on the measurement results obtained by the acceleration sensor 307.

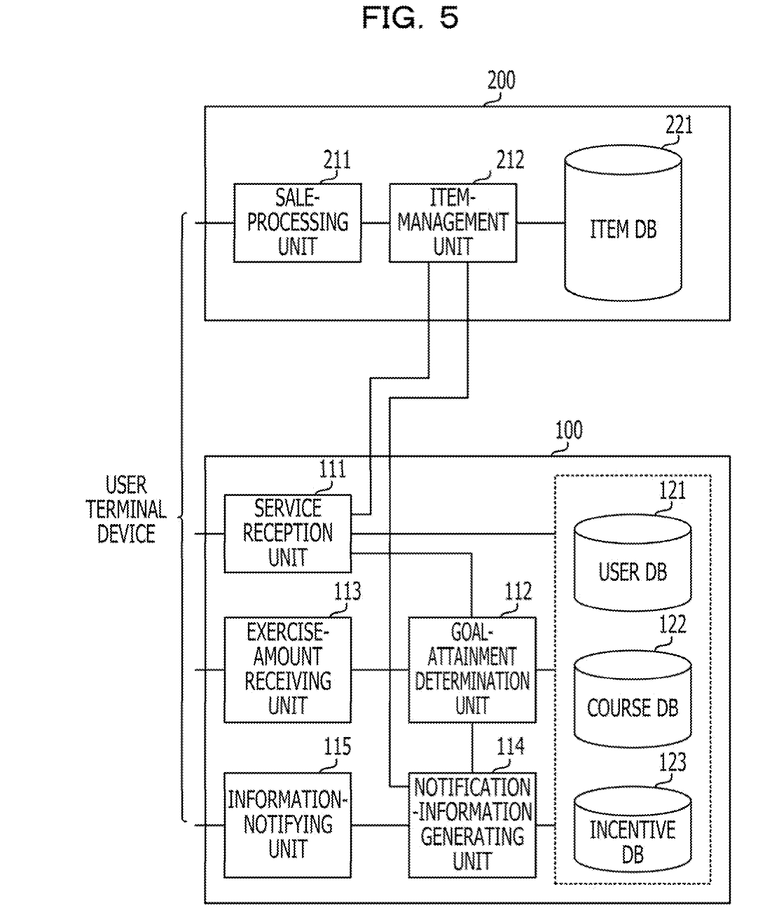

Next, the processing in the computer system of this embodiment will be described. FIG. 5 is a block diagram illustrating processing functions of an EC server and an exercise management server.

An EC server 200 includes a sale-processing unit 211 and an item-management unit 212. Processing in the sale-processing unit 211 and processing in an item-management unit 212 may be realized, for example, by executing predetermined programs by the CPU of the EC server 200, respectively. The HDD in the EC server 200 stores an item DB 221. The item DB 221 may be stored in the storage device provided outside of the EC server 200.

On the other hand, the exercise management server 100 includes a service reception unit 111, a goal-attainment determination unit 112, an exercise-amount receiving unit 113, a notification-information generating unit 114, and an information-notifying unit 115. The processing in the respective units may be realized, for example, when the CPU 101 of the exercise management server 100 executes the predetermined programs. The HDD 103 of the exercise management server 100 stores a user DB 121, a course DB 122, and an incentive DB 123. The user DB 121, the course DB 122, and the incentive DB 123 may be stored in a storage device placed outside of the exercise management server 100.

The respective functions of the EC server 200 and exercise management server 100 may be realized by, for example, the same server.

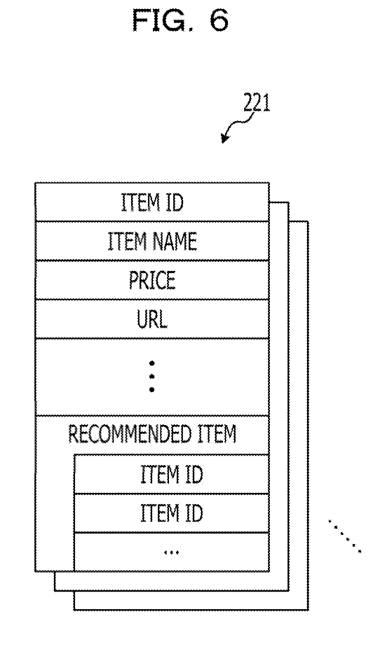

Here, FIG. 6 is a diagram illustrating data stored in the item DB.

A record is registered into the item DB 221 for every commercial item. Each record in the item DB 221 registers the URL of the Web page that introduces a commercial item ID for identifying commercial item, an item name, an item price, the details of the item, and so on. Furthermore, information about recommended items for every commercial item is registered in the item DB 221. The term “recommended item” means a commercial item which is further recommended for a user who has purchased an item corresponding to the record or registered it as a reward item. In each record in the item DB 221, therefore, item IDs, which represent recommended items, are registered. The recommended items registered in the item DB 221 may be previously determined or may be dynamically determined according to the sales of the item.

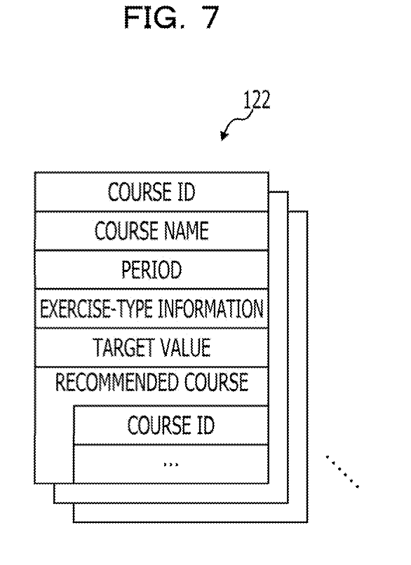

FIG. 7 is a diagram illustrating exemplary data stored in a course DB.

A record is registered into the course DB 122 for every exercise management course. Two or more exercise management courses are prepared in order that the exercise management server 100 may manage a user's exercise amount. In the present embodiment, an exercise-amount managing period, a managing-exercise type, and a target exercise amount are assigned for every exercise management course.

As illustrated in FIG. 7, a course ID for identifying an exercise management course, a course name, an exercise-amount managing period, exercise-type information for representing a type of exercise amount, and a target exercise amount are registered in the record of each exercise management course. When the user joins an exercise management course, the management server 100 manages whether the amount of exercise has reached the target level based on the information transmitted from the user terminal device within a period set in the participating exercise management course.

In the present embodiment, a period, exercise-type information, and a target exercise amount are defined in advance for every exercise management course. Alternatively, however, the user may arbitrarily determine these conditions.

Furthermore, a recommended course is recorded in the record of each exercise management. The recommended course recommends the user, who has attained the target exercise amount within a predetermined period, to participate in a next recommended course. Thus, a course ID for identifying the recommended course is registered in the record. Two or more course IDs of different recommended courses may be recorded in one record.

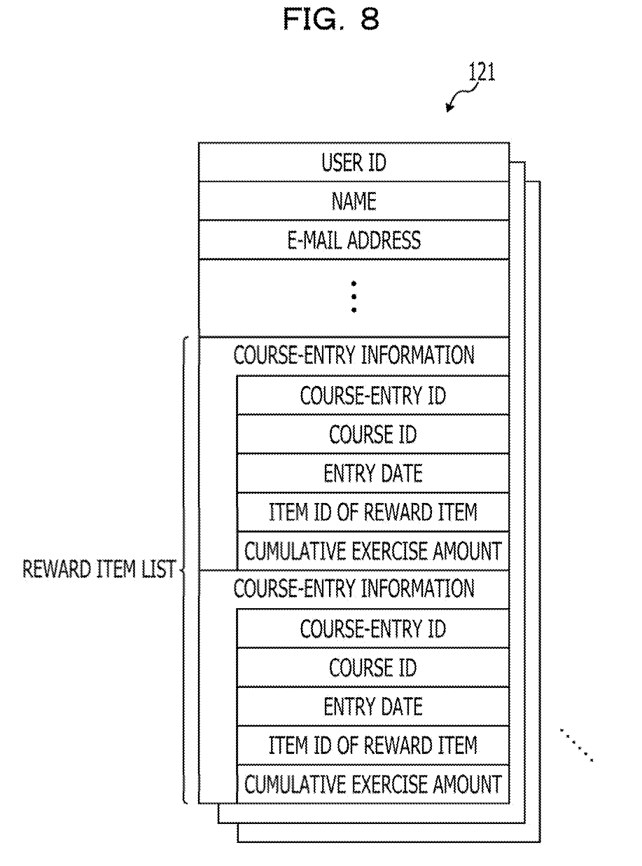

FIG. 8 is a diagram illustrating exemplary data stored in a user DB.

A user DB 121 registers a record for every user. Each record in the user DB 121 records user's individual information, such as a user ID for identifying the user and the user's name or e-mail address. Furthermore, each record in the user's DB 121 registers a reward list.

The reward list includes course-entry information about a set of: a course ID that represents an exercise management course in which the user participates, a course-entry date when the user participated in the exercise management course, and an item ID that represents an item as a reward item (i.e., purchasable item). The course-entry information is provided with a course-entry ID, which is unique discrimination information. A cumulative exercise amount is registered in each piece of course-entry information after the start of the course. The cumulative exercise amount is an accumulated amount of exercise received from the user terminal device, which is calculated at the starting point of the course-entry date. When the user is able to simultaneously join two or more exercise management courses, entry information for the respective courses is registered in the reward list.

In the example of FIG. 8, the course ID, which indicates a participating exercise management course, is registered in each course-entry information in the reward list. For example, instead of the course ID, a management period, exercise-type information, and target exercise amount may be registered.

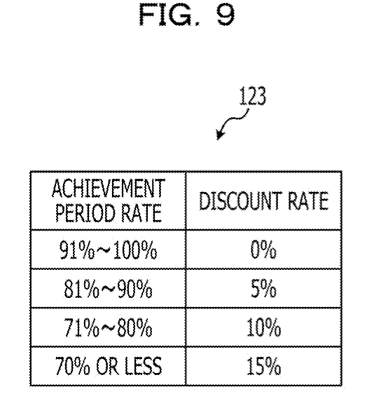

FIG. 9 is a diagram illustrating exemplary data stored in an incentive DB.

As described later, the exercise management server 100 gives an incentive to the user participating the exercise management course depending on a situation until the user attains the target exercise amount, or the like. In the present embodiment, as an exemplary incentive, the selling price of the commercial item registered in the reward list is discounted.

A discount rate is set in the incentive DB 123 for every range of an achievement period rate. An achievement period rate is a rate of a period until the amount of exercise reaches a target level in relation to an exercise-amount managing period (namely, a period set to each record of the course DB 122). In the example of FIG. 9, the smaller the achievement period rate (or the shorter the period until the amount of exercise reaches a target level), the higher the setting of the discount rate.

Hereinafter, referring back to FIG. 5, processing functions of the EC server 200 and the exercise management server 100 will be described, respectively.

In the EC server 200, the sale-processing unit 211 has a Web-server function that offers an item-selling Web site. The sale-processing unit 211 displays a Web-page screen for allowing the user to select item information stored in the item DB 211 on the user terminal device, such as a cell phone 300 or PC 400. Then, the user is allowed to select and input the item of interest. Furthermore, the sale-processing unit 211 displays the Web-page screen that makes a user perform a purchase procedure of the selected item on the user terminal device. The sale-processing unit 211 accepts the input of information, including information of credit card, information of item delivery address, and information required for item purchase. Then, purchase processing is completed.

In response to a request from the sale-processing unit 211 or the exercise management server 100, the item-management unit 212 searches the item information of interest from the item DB 221, and outputs a retrieval result to the requestor.

On the other hand, in the exercise management server 100, the service reception unit 111 has a Web-server function that offers a Web site as a window for the user who intends to use an exercise management service. The service reception unit 111 displays, for example, a Web page for accepting selection of an item to be registered in the reward list, selection and participation of an exercise management course, and so on the user terminal devices, such as cell phone 300 and PC 400.

When the service reception unit 111 displays a Web page, it acquires the information about the item to be registered in the reward list from the item DB 221 through the item-management unit 212 of the EC server 200. Furthermore, the service reception unit 111 acquires the information about the exercise management course to be provided as a user's selection target from the course DB 122. The service reception unit 111 registers the information about the item selected by the user and the information about the user-participating exercise management course in the user DB 122. In addition, the service reception unit 111 makes the goal-attainment determination unit 112 start the exercise-management processing corresponding to the participating exercise management course.

The goal-attainment determination unit 112 performs the exercise-management processing corresponding to the user-participating exercise management course. The goal-attainment determination unit 112 manages a user's exercise amount based on the information registered in the course-entry information for every piece of course-entry information registered in the user DB 121. The goal-attainment determination unit 112 receives the user's exercise amount through the exercise-amount receiving unit 113. When the received user's exercise amount reaches a target level, the goal-attainment determination unit 112 notifies the notification-information generating unit 114 of such a fact.

The exercise-amount receiving unit 113 receives the user's exercise amount transmitted from the user terminal device, and notifies it to the goal-attainment determination unit 112. As described later, for example, the amount of exercise of the user participating the exercise management course is automatically transmitted for every definite period of time from cell phone 300.

The notification-information generating unit 114 generates information to be notified to the user who has attained the target amount of exercise. When the notification-information generating unit 114 receives a notice that the user has reached the target exercise amount, the notification-information generating unit 114 specifies the record of the user DB 121 corresponding to the user. The notification-information generating unit 114 acquires the information about the item in the reward list from the item DB 221 through the item-management unit 21 of the EC server 200 based on the information registered in the specified record. In addition, the notification-information generating unit 114 acquires the information about the recommended course from the course DB 122.

The notification-information generating unit 114 generates information about the item in the reward list, URL of a Web page that accepts item-purchase application, notice information including recommended course information, and so on. Next, the notification-information generating unit 114 outputs the generated usual state method to the information-notifying unit 115. Based on the information on incentive DB 123, the notification-information generating unit 114 discounts the selling price of the item in the reward list according to a period which the user has taken to achieve the goal. The notification-information generating unit 114 describes the price and the discount rate after the discount in the notification information.

The information-notifying unit 115 transmits the notice information as an e-mail output from the notification-information generating unit 114 to a user's e-mail address.

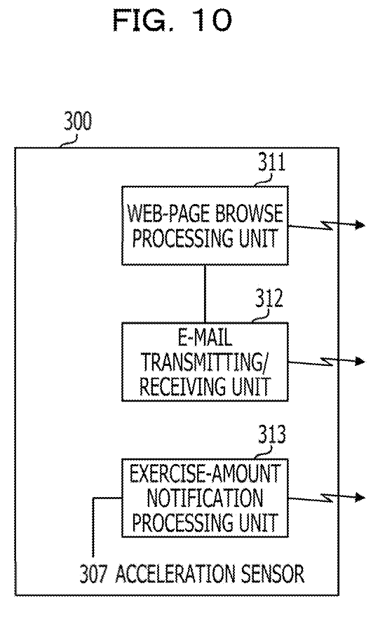

FIG. 10 is a block diagram illustrating processing functions of a cell phone. The cell phone 300 includes a Web-page browse processing unit 311, an e-mail transmitting/receiving unit 312, and an exercise-amount notification processing unit 313.

Processing of the Web-page browse processing unit 311 is realized, for example, when a control circuit 303 of the cell phone 300 executes a predetermined web browser program. The Web-page browse processing unit 311 accesses a Web server according to the operation input of the user of the cell phone 300, and receives data from the Web page. Then, the Web-page browse processing unit 311 allows a display 306a to display the Web page thereon. In addition, the Web-page browse processing unit 311 transmits information to the Web server according to operation input on a linked image or the like in the Web page.

For example, from the service reception unit 111 of the exercise management server 100, the Web-page browse processing unit 311 receives data from Web pages, such as those for accepting reward list selection and selection/participation of exercise management course, and displays these Web pages on the display 306a. In this case, the user of the cell phone 300 performs the selection operation of reward list and the selection/participation operation of exercise management course through the displayed Web page. The Web-page browse processing unit 311 transmits input information to the service reception unit 111 of the exercise management server 100 according to the user's operation.

Processing of e-mail transmitting/receiving unit 312 is realized, for example because control circuit 303 of cell phone 300 executes a predetermined e-mail transceiver program. The e-mail transmitting/receiving unit 312 receives an e-mail, which has been transmitted from the information-notifying unit 115 of the exercise management server 100 to an e-mail address of the user of the cell phone 300, through an e-mail server (not illustrated in the figure) on a network 500. When the user clicks the linked image of URL described on the received e-mail, for example, the Web-page browse processing unit 311 may also request access to the URL to the e-mail transmitting/receiving unit 312.

Processing of the exercise-amount notification processing unit 313 is realized by, for example, when the control circuit 303 of the cell phone 300 executes a predetermined application program for notice of the amount of exercise. This exercise-amount notifying application program is installed in the non-volatile memory 304 of the cell phone 300 from an external server, such as an exercise management server 100, through the network 500 or through a portable storage medium (not illustrated).

The exercise-amount notification processing unit 313 always receives measuring results obtained by the acceleration sensor 307, and then accumulates the received measuring results in the non-volatile memory 304 of the cell phone 300, or the like. The exercise-amount notification processing unit 313 calculates the amount of exercise, such as the number of steps and the amount of activity, based on measuring results accumulated periodically, for example one time per day, and then transmits the calculated exercise amount to the exercise-amount receiving unit 113 of the exercise management server 100.

Next, the exercise management server 100, the EC server 200, and the user terminal device will be described. In the following description, the cell phone 300 is used as a user terminal device.

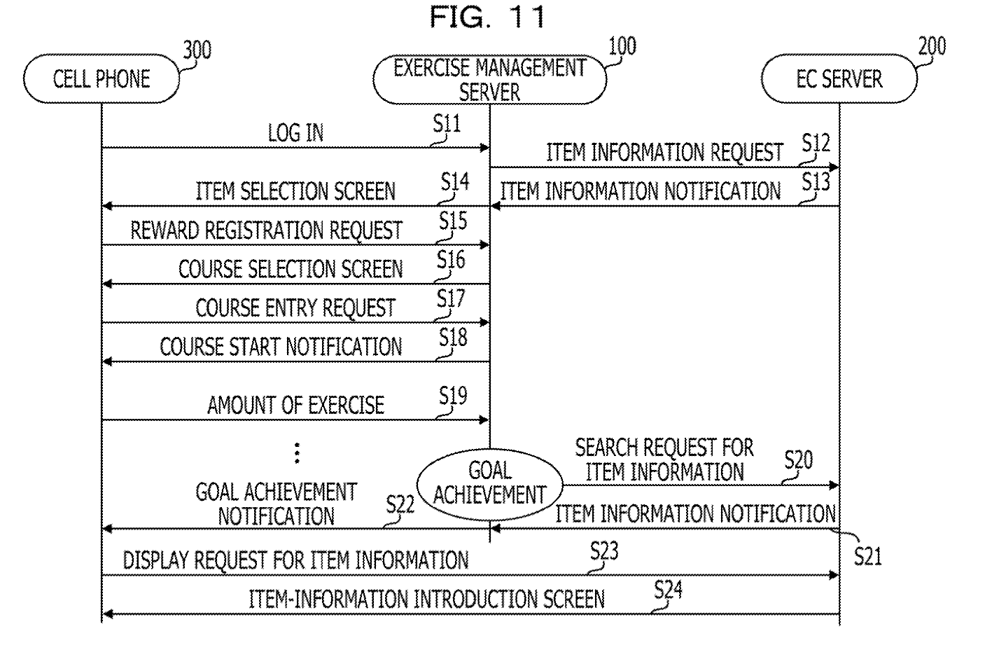

FIG. 11 is a sequence diagram illustrating processing performed among the exercise management server, the EC server, and the cell phone.

The user who intends to participate an exercise management course provided by the exercise management server 100 browses the Web site of the exercise management server 100, for example, by starting a Web browser of the cell phone 300. In the cell phone 300, the web browser is executed to activate the Web-page browse processing unit 311. The Web-page browse processing unit 311 accesses the URL of the Web page for login, which is provided by the exercise management server 100 in response to the user's input operation and then displays the Web page for login on the display 306a. The user enters login information, such as user ID and a password, into predetermined regions in the Web page for login, and performs a long-in request operation. The Web-page browse processing unit 311 transmits input login information to the exercise management server 100, and requests login (Operation S11).

The service reception unit 111 of the exercise management server 100 performs user authentication based on the received log-in information. When it is authenticated correctly, the service reception unit 111 requests the EC server 200 to provide information about item to be provided to the user (Operation S12). The item-management unit 212 of the EC server 200 reads information, such as item ID, brand name, and price, about one or more items from the item DB 221, and then transmits the information to the service reception unit 111 of the exercise management server 100 (Operation S13).

The service reception unit 111 of the exercise management server 100 generates a Web page of item-selection screen to make the user select a reward item based on the information on the commercial item received from the item-management unit 212 of the EC server 200. Then the service reception unit 111 transmits the data of the Web page to the cell phone 300 (Operation S14). The Web-page browse processing unit 311 of the cell phone 300 displays the Web page of an item-selection screen on the display 306a based on the received data.

The user selects one of items displayed on the display 306a and registers the selected item as a reward item into a reward list. The Web-page browse processing unit 311 transmits a commercial item ID of the reward item, which has been requested to be registered, to the exercise management server 100 in response to the user's operation (Operation S15). The service reception unit 111 of the exercise management server 100 generates one course-entry information in the record corresponding to the user who logged in among the records of the user DB 121. The service reception unit 111 registers a unique course-entry ID and commercial item ID which is received from the Web-page browse processing unit 311 of cell phone 300 into the generated course-entry information.

Next, the service reception unit 111 extracts information about each of a plurality of exercise management courses from the course DB 122. Here, the information includes, for example, a course ID, a course name, a period, exercise-type information, and a target value. The service reception unit 111 generates a Web page of a courses selection screen for allowing the user to select an excursive management courser based on the information extracted from the course DB 122. Then, the data of Web page is transmitted to the cell phone 300. (Operation S16) The Web-page browse processing unit 311 of the cell phone 300 displays the Web page of a course selection screen on the display 306a based on the received data.

The user selects one of exercise management course displayed on the display 306a and then performs a request of entering the selected exercise management course. The Web-page browse processing unit 311 of the cell phone 300 transmits the course ID of the selected exercise management course to the exercise management server 100 in response to the user's operation (Operation S17). The service reception unit 111 of the exercise management server 100 registers the user-selected course ID in the course-entry information of the user in user DB 121, which is generated after Operation S15. In addition, the course-entry information and the present date as a course entry data are registered in the same course-entry information. The service reception unit 111 registers an initial value “0” as a cumulative exercise amount in the course-entry information.

When the above processing is completed, the service reception unit 111 generates the Web page that notifies the user of the start of the course in which entry was requested. Next, the data of the Web page is transmitted to the cell phone 300 (Operation S18). In the Web page which is transmitted at this time, the course-entry ID registered in the course-entry information after execution of Operation S15 is described. The user may recognize the start of a course, where the user is requested to participate, and the course-entry ID from the information about Web page displayed on the display 306a. Furthermore, for example, the user may be notified of the start of the course and the course-entry ID through an e-mail addressed to the user.

In the above processing, the selection operation of a reward item and the selection operation of an exercise management course are performed through the cell phone 300. Alternatively, the user may perform any of these selection operations through another terminal apparatus, such as a personal computer (PC) 400. In this case, the same processing as that of Operations S11 to S18 is executed between another user terminal and the exercise management server 100.

In addition, in the above processing, the exercise management server 100 accepts the selection of a reward item, followed by accepting the selection of an exercise management course. Alternative, however, the selection of an exercise management course may be performed before accepting the selection of a reward item.

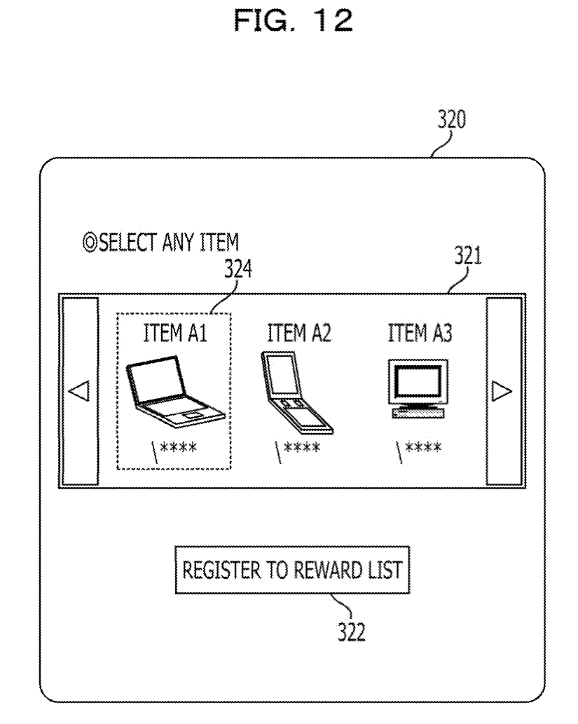

Here, FIG. 12 is a diagram illustrating an exemplary display of an item-selection screen.

An item-selection screen 320 illustrated in FIG. 12 is an exemplary Web page displayed on the display 306a of the cell phone 300 according to Operation S14 illustrated in FIG. 11. For example, the item-selection screen 320 displays an item selection section 321 and a registration request button 322. The item-selection screen 320 displays information about commercial item which can be selected by the user as a reward item. In the example of FIG. 12, three commercial items can be displayed at once and it is also possible to display another commercial item by moving the cursor 324 to right and left.

The user of cell phone 300 moves the cursor 324 on information about desired item to select an item to be used as a reward. Then, a determination operation is performed on the registration request button 322 to request the exercise management server 100 to register the selected item as a reward item in the reward list. Information images of the respective items displayed on the item-selection screen 320 are provided with corresponding item IDs received from the exercise management server 100. When the determination operation is performed on the registration request button 322, the Web-page browse processing unit 311 of the cell phone 300 transmits the item ID corresponding to the item selected on the item selection screen 320. Commercial item ID corresponding to a selected item to service reception unit 111 of exercise management server 100 on item-selection screen 320, if determination operation to registration request button 322 is performed.

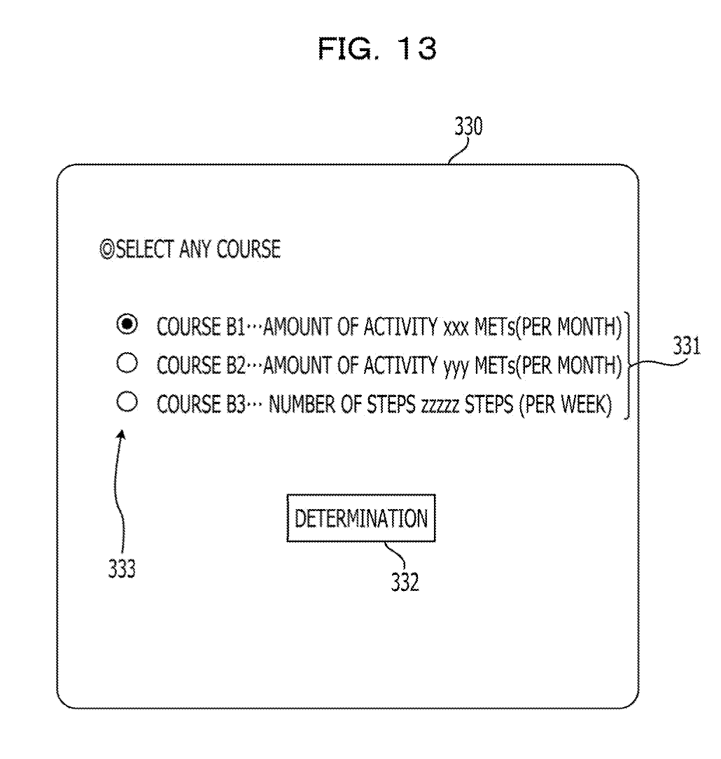

FIG. 13 is a diagram illustrating an exemplary window of a course-selection screen.

A course selection screen 330 illustrated in this FIG. 13 is an example of the Web page displayed on the display 306a of the cell phone 300 in Operation S16 of FIG. 11. For example, the course selection screen 330 displays a course selection section 331 and a determination button 332. The course selection section 331 displays a list of course names and contents of exercise management courses that have been received from the service reception unit 111 of the exercise management server 100.

In the figure, course-selection radio buttons 333 are arranged on the left side of the course selection section 331. The user may select any of these radio buttons 333 and then performs a determination operation on a determination button 332 to request entry of the selected exercise management course to the exercise management server 100. The radio buttons 333 correspond to the respective course IDs received from the exercise management server 100. When the determination operation is performed on the determination button 332, the Web-page browse processing unit 311 of the cell phone 300 transmits the course ID corresponding to the selected radio button 333 to the service reception unit 111 of the exercise management server 100.

Then, referring back to FIG. 11, processing after the user joins the exercise management course will be described.

The user who received the start notice of the exercise management course by processing of Operation S18 makes the cell phone 300 executes an exercise-amount notifying application program. Therefore, the cell phone 300 starts the exercise-amount notification processing unit 313. The user sets the course-entry ID received together with start notice of the exercise management course and class of exercise amount notified to the exercise management server 100 in the exercise-management processing corresponding to this course-entry ID to the exercise-amount notification processing unit 313.

The exercise-amount notification processing unit 313, where the setting thereof is completed, starts accumulation processing of the measuring results by the acceleration sensor 307. The exercise-amount notification processing unit 313 calculates the amount of exercise corresponding to the predetermined class based on the accumulated measuring results, and transmits the calculation result of the exercise amount and course-entry ID to the exercise management server 100 at a predetermined time (Operation S19). Processing of transmitting the amount of exercise and course-entry ID by the exercise-amount notification processing unit 313 is performed repeatedly until an amount of exercise reaches a target level or until the period of the exercise-management processing corresponding to a course-entry ID expires.

The exercise-amount receiving unit 113 of the exercise management server 100 receives the amount of exercise and course-entry ID which were transmitted from the cell phone 300, and outputs them to the goal-attainment determination unit 112. The goal-attainment determination unit 112 searches a user's course-entry information, in which course-entry ID received from the exercise-amount receiving unit 113 is registered, from the user DB 121. The goal-attainment determination unit 112 searches a target exercise amount from the course DB 122. The target exercise amount was set up in the exercise management course corresponding to the course ID in the course-entry information searched from the user DB 121.

The goal-attainment determination unit 112 adds the cumulative exercise amount registered in the course-entry information searched from the user DB 121 to the amount of exercise received from the exercise-amount receiving unit 113. Then the goal-attainment determination unit 112 determines whether the sum has reached the target level searched from the course DB 122. Here, when the additional value has reached the target level, the goal-attainment determination unit 112 notifies what the target attained to notification-information generating unit 114.

The notification-information generating unit 114, which has received the notice, transmits the item ID of the reward item registered into the course-entry information corresponding to the course in which the goal was attained to the EC server 200, and requires search of merchandise information (Operation S20). The item-management unit 212 of the EC server 200 searches item DB 221 using the commercial item ID received from the notification-information generating unit 114 of the exercise management server 100. The item-management unit 212 of EC server 200 extracts information, including an item name, a price, URL, and the like, which correspond to the commercial item ID. The item-management unit 212 extracts the commercial item ID of the recommended item registered in the received record of commercial item ID, and also extracts information, including the item name, price, and the like corresponding to the extracted commercial item ID. The item-management unit 212 transmits the information extracted from the item DB 221 to the notification-information generating unit 114 of the exercise management server 100 (Operation S21).

The notification-information generating unit 114 of the exercise management server 100 extracts the course ID of the recommended course in the record with reference to the record of course DB 122 corresponding to the course on which the user attained the goal. The notification-information generating unit 114 extracts the recommended course information with reference to the record of course DB 122 corresponding to the extracted course ID.

The notification-information generating unit 114 requests the information-notifying unit 115 to send a notice of goal achievement containing the information received from the EC server 200 and the recommended course information extracted from the course DB 122. Here, based on the information on incentive DB 123, the notification-information generating unit 114 discounts the selling price of the item in the reward list according to a period which the user has taken to achieve the goal. The notification-information generating unit 114 describes the price and the discount rate after the discount in the notification of goal achievement. The notification-information generating unit 114 extracts e-mail address of the user who attained the goal from the user DB 121, and outputs it to the information-notifying unit 115. The information-notifying unit 115 transmits a notice of goal achievement including the information received from the notification-information generating unit 114 as an e-mail where the user's e-mail address of the cell phone 300 is used as a destination address (Operation S22).

The e-mail transmitting/receiving unit 312 of the cell phone 300 receives e-mail addressed to the user of the cell phone 300. The received e-mail describes that the goal has been achieved, while describing information about reward items. The user may browse the e-mail and checks the information about reward items.

In the above processing, before making the user start an exercise management course, the exercise management server 100 makes a user select a reward item, and holds information about the selected item to a reward list. The exercise management server 100 receives the amount of exercise periodically from the cell phone 300, and manages whether the amount of exercise reaches a target level in a predetermined period. When the user's exercise amount reaches the target level within a predetermined period of time, the exercise management server 100 notifies the user of the information about the reward item and also notifies the user of the information about the reward item in the reward list.

Thus, when the user's exercise amount reaches a target level, the user is notified of the information about a commercial item registered as a reward item in advance. Therefore, the user may be prevented from forgetting purchasing the reward item. Thus, the user may certainly purchase the item. For example, comparing with the case where the information about a purchase candidate item is only registered into what is called a wish list, the user may surely keep motivation to buy a purchase-candidate item until the amount of exercise reaches the target level. Thus, the user's opportunity of purchasing commercial items increases and sales of commercial items may be promoted.

For example, an e-mail addressed and transmitted to the user at Operation S22 may indicate an image linked to URL of the Web page that introduces information about a reward item. In this case, the user can operate and request the Web-page browse processing unit 311 to access to the linked URL of the image described in the e-mail. Here, the Web-page browse processing unit 311 accesses the EC server 200, and requests the EC server 200 to display the Web page which introduces the information about the reward item (Operation S23).

The sale-processing unit 211 of the EC server 200 transmits a Web-page data of an item-information introducing screen to the cell phone 300 according to access from the cell phone 300 (Operation S24). The user checks the details of the reward item through the Web page displayed on the cell phone 300 by processing of Operation S24. Then the user may advance a purchase procedure of the item. For example, the Web page displayed on the cell phone 300 by processing of Operation S24 may be one of the Web pages displayed while advancing the purchase procedure of a reward item.

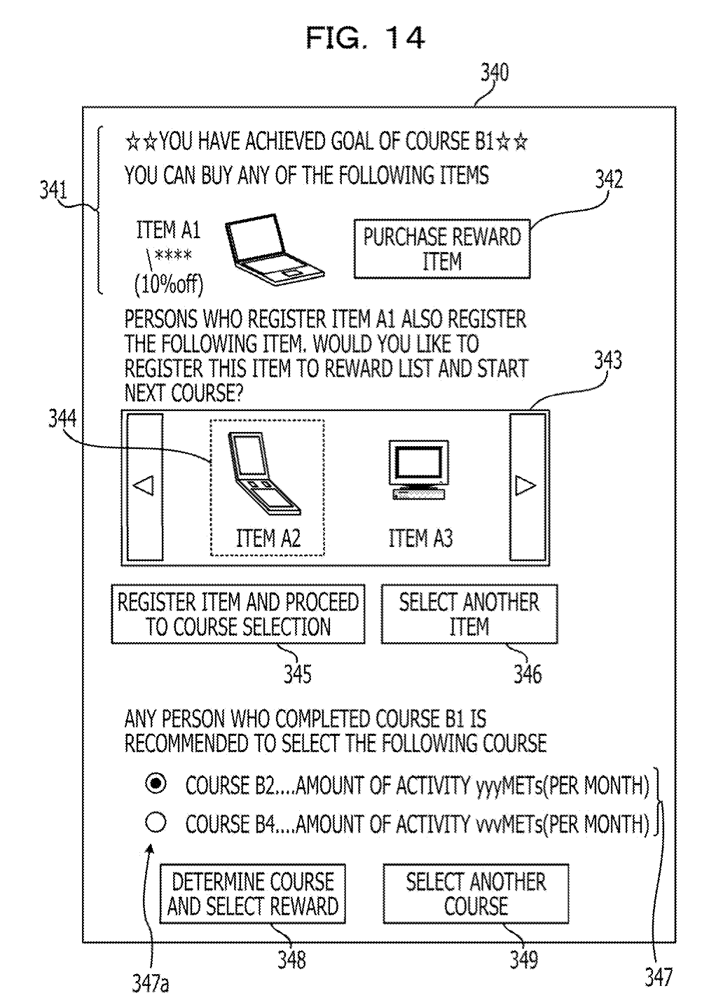

FIG. 14 is a diagram illustrating exemplary contents of an e-mail which notifies goal achievement.

An e-mail document 340 illustrated in FIG. 14 is an exemplary representation of an e-mail. In Operation S22 of FIG. 11, this e-mail is transmitted from the information-notifying unit 115 of exercise management server 100 to the destination of the e-mail. This e-mail document 340 is described by, for example, HTML (Hyper Text Markup Language).

The e-mail document 340 displays an item information section 341 where information about the reward item is described. The reward item has been registered at the time of entry into the exercise management course where the user has achieved the goal. The item information section 341 describes, for example, the item name and price of the reward item. When the incentive is given by the exercise management server 100, the price of the reward item is a discount price and a discount rate is also described with the discount price.

The item information section 341 contains a purchase request button 342. The purchase request button 342 is a linked image corresponding to URL of the Web page that introduces the information about the reward item. When the user selects and presses the purchase request button 342, the Web-page browse processing unit 311 is activated. Then, access to the linked URL corresponding to the purchase request button 342 is performed by processing of the Web-page browse processing unit 311. Here, as illustrated in Operation S23 of FIG. 11, the cell phone 300 requests the EC server 200 to represent the item information.

The URL corresponding to the purchase request button 342 may be URL of the Web page for purchase procedures which purchases a reward item. Alternatively, in the e-mail document 340, the Web-page URL for reward item introduction or purchase procedures may be described as text information instead of the purchase request button 342.

In the case where the price of the reward item described on the item information section 341 is discounted, when the Web-page browse processing unit 311 accesses the linked-URL corresponding to the purchase request button 342, the Web-page browse processing unit 311 transmits the discount rate given to the reward item to the EC server 200. When a purchase application of a reward item is made through the Web page which the linked URL corresponding to purchase request button 342, the sale-processing unit 211 of the EC server 200 performs settlement processing with the application of the discount rate received from the Web-page browse processing unit 311.

The price discount method for selling the reward item is not limited to one described above. Alternatively, for example, the following procedure may be applicable. When the notification-information generating unit 114 of the exercise management server 100 sends a notice of goal achievement to the cell phone 300 in Operation S22 of FIG. 11, it notifies the sale-processing unit 211 of the EC server 200 of user ID, reward item ID, and discount rate. The sale-processing unit 211 holds the user ID, commercial item ID, and discount rate from the notification-information generating unit 114 to the non-volatile storage medium (for example, HDD) in the EC server 200. The sale-processing unit 211 accepts purchase application for a reward item by a procedure which is initiated by selective operation to the purchase request button 342 in the e-mail document 340 of FIG. 14. Thus, a discount rate, which corresponds to the user ID of the user who made a purchase application and commercial item ID of the reward item performs settlement processing with the application of the held discount rate, is stored in a non-volatile storage medium. In this case, settlement processing is performed with the application of the held discount rate.

The e-mail document 340 displays an item selection section 343 that selects a recommended item. The item selection section 343 is displayed for the purpose of recommending entry to a new exercise management course. The user moves a cursor 344 on the information about a desired item in the item selection section 343 to select a commercial item as a reward item. Then, after selecting the item to be provided as a new reword item, a determination operation is performed on the registration request button 345 to request the exercise management server 100 to register the selected item as a reward item in the reward list.

When the determination operation is performed on the registration request button 345, the Web-page browse processing unit 311 is started. The Web-page browse processing unit 311 accesses the linked URL corresponding to the registration request button 345, while transmitting the item ID corresponding to the item on which the cursor 344 is located to the exercise management server 100, which is an access destination. In this case, the service reception unit 111 of the accessed exercise management server 100 becomes the same state as one where the registration request of the item is received in Operation S15 in FIG. 11. Next, in a manner similar to Operation S16, a course selection screen is displayed on the cell phone 300.

When a user-desired item is not included in the item selection section 343, the user performs a determination operation on the selection request button 346. Thus, the exercise management server 100 may be requested to display a Web page on which any item is selectable. In this case, like Operation S14 of FIG. 11, the service reception unit 111 of the exercise management server 100 displays the Web page of the item-selection screen on the cell phone 300, and accepts entry to an exercise management course in the same procedure as that of Operation S14 of FIG. 11 or subsequent ones.

The e-mail document 340 displays a course selection section 347 that accepts the selection operation of a recommended course. This course selection section 347 as well as the item selection section 343 is displayed for the purpose of recommending entry to a new exercise management course. The course selection section 347 displays a list including recommended courses registered in the course DB 122 corresponding to the exercise management course where the achievement of the goal is notified by the e-mail document 340.

The course selection section 347 includes radio buttons 347a corresponding to the respective displayed recommended courses. The user may check and select any of these radio buttons 347a and then performs a determination operation on a determination button 348 to request entry of the selected exercise management course to the exercise management server 100. In this case, the service reception unit 111 of the exercise management server 100 registers information about the determined exercise management course to the user DB 121 in a manner similar to the case, for example, where the entry to the exercise management course is received in Operation S17 in FIG. 11. Then, processing like Operation S12-S15 of FIG. 11 is performed between the service reception unit 111 and the cell phone 300. Information about the reward item is registered into the user DB 121, and processing of an exercise management course is started in the same procedure as Operation S18 or subsequent ones.

When the course selection section 347 does not display a desired exercise management, the user may perform a determination operation on the selection button 349. A Web page on which any exercise management course is selectable can be also displayed on the display 306a of the cell phone 300.

The e-mail document 340 illustrated in FIG. 14 as described above notifies the user of not only the information about items in a reward list with completion of an exercise management course but also the information about recommendation of entry to a new exercise management course or purchase of a new commercial item. Therefore sale of commercial items may be promoted further.

The notifying method of a recommended item or a recommended course using the above e-mail document 340 is for illustrative purposes only. Alternatively, another method may be used for notifying the user of recommended items and recommend course. For example, although the e-mail document which notifies goal achievement displays the above item selection section 343 and registration request button 345, a recommended item may be not displayed. The user determines the desired item in the item selection section 343, and performs a determination operation on the registration request button 345. Then, the service reception unit 111 of the exercise management server 100 displays the Web page of the selection screen of a recommended course on cell phone 300. The user selects a desired exercise management course among the recommended courses in the list displayed on the selection screen and then requests the exercise management server 100 to entry to the course. Therefore, a new exercise management course newly chosen by this is started.

In the e-mail document 340 described above, a recommended item is selected as a reward item. Then, a new exercise management course may be selected. As another example, a recommended item described together with a reward item in an e-mail document may be recommended to be purchased together with the reward item. In this case, for example, a purchase procedure may be advanced by selectively operating a linked image on the e-mail document, representing an introduction page or a purchase page of a recommended item, which is offered by the sale-processing unit 211 of the EC server 200, on the cell phone 300, and allowing the user to buy the item.

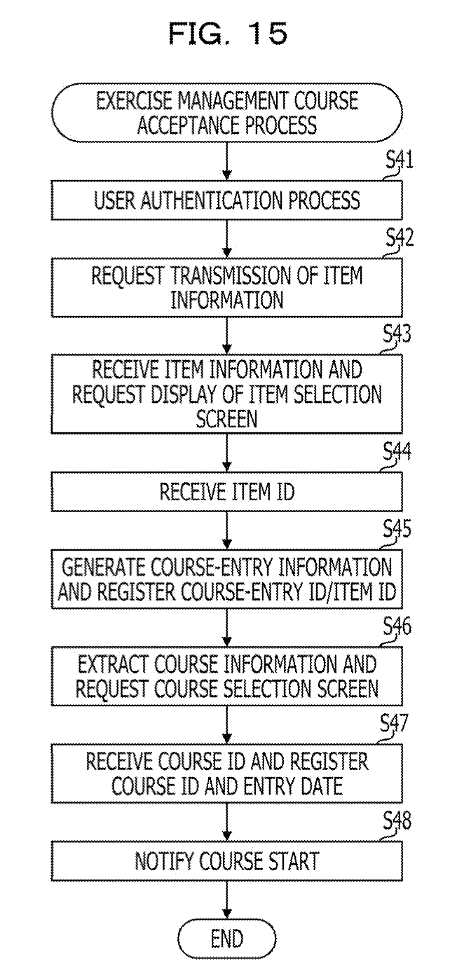

Next, processing of the exercise management server 100 will be described using a flow chart. First, FIG. 15 is a flow chart illustrating processing of an exercise management server when enrollment in an exercise management course is accepted.

[Operation S41]

The service reception unit 111 of the exercise management server 100 displays the Web page for login to cell phone 300. Log-in information, such as user ID and a password, are transmitted from the Web-page browse processing unit 311 of the cell phone 300 (corresponding to Operation S11 of FIG. 11). The service reception unit 111 receives the log-in information and performs user-authentication processing. The service reception unit 111 performs processing of Operation S42 when the user is correctly authorized.

[Operation S42]

The service reception unit 111 requests the item-management unit 212 of the EC server 200 to transmit the information about the commercial item to be represented to the user (corresponding to Operation S12 of FIG. 11).

The item-management unit 212 of the EC server 200 which has accepted the request to send reads information about item IDs, names, and prices of a plurality of commercial items from the item DB 221 and transmits the information to the service reception unit 111 of the exercise management server 100 (corresponding to Operation S13 of FIG. 11). For example, the information about commercial items which the item-management unit 212 transmits to the service reception unit 111 at this time may be previously determined as those to be sold to the user through the exercise management server 100.

Alternatively, the service reception unit 111 may display the Web page for commercial-item search on the cell phone 300 as another example of processing of Operation S42. In this case, a search key, which has received from cell phone 300 according to an input operation to the Web page for commercial item search, may be transmitted the item-management unit 212 of the EC server 200. In this case, the item-management unit 212 of the EC server 200 searches the item DB 221 using the search key received from the service reception unit 111 of the exercise management server 100. The item-management unit 212 extracts information about a commercial item which has matched the search key from the item DB 221, and transmits the information to the service reception unit 111 of the exercise management server 100.

[Operation S43]

The service reception unit 111 of the exercise management server 100 generates a Web page of item-selection screen to make the user select a reward item based on the information on the commercial item received from the item-management unit 212 of the EC server 200. The service reception unit 111 transmits the data of the generated Web page to the cell phone 300, and requests the display of an item-selection screen (corresponding to Operation S14 of FIG. 11)

[Operation S44]

The service reception unit 111 receives commercial item ID of the item selected by the user from cell phone 300 (corresponding to Operation S15 of FIG. 11).

[Operation S45]

The service reception unit 111 extracts the record corresponding to the user of the cell phone 300 among the records of user DB 121. The service reception unit 111 generates one course-entry information on the extracted record. Then, the service reception unit 111 registers a unique course-entry ID and commercial item ID, which is received from the cell phone 300 in Operation S44, into the generated course-entry information.

[Operation S46]

The service reception unit 111 extracts the information about a plurality of exercise management courses from the course DB 122. For example, the information about the respective exercise management courses extracted from the course DB 122 at this time may include course IDs, course names, periods, exercise-type information, and target levels. The service reception unit 111 generates data of the Web page of the course selection screen for selecting an exercise management course based on the information about the exercise management course extracted from the course DB 122. The service reception unit 111 transmits the data of the generated Web page to the cell phone 300, and requests display of the course selection screen (corresponding to Operation S16 of FIG. 11).

[Operation S47]

The service reception unit 111 receives the course ID of the exercise management course selected by the user from the cell phone 300 (corresponding to Operation S17 of FIG. 11). The service reception unit 111 registers the course ID received from the cell phone 300 to the course-entry information generated in Operation S45. Then the service reception unit 111 registers the present date as an entry date, and also registers an initial value of “0” as a cumulative exercise amount.

Although an exercise-amount managing period and target exercise amount are set up in advance for every exercise management course, as another embodiment of the present invention, the user may enable it to set up target exercise amount. For example, when an exercise-amount managing period and a target level range, which can be considered as target exercise amount, are previously determined for every exercise management course, the user may select an exercise management course while setting arbitrarily as target exercise amount from the target level range. In this case, in Operation S47, the service reception unit 111 receives the target exercise amount set up by the user with the course ID chosen by the user, and registers the target exercise amount which received into course-entry information.

[Operation S48]

The service reception unit 111 generates Web-page data. The Web-page data reports that the exercise management course corresponding to the course ID received in Operation S47 is started. This Web page displays the course-entry ID of the course-entry information generated in Operation S45. The service reception unit 111 transmits the data of the generated Web page to the cell phone 300, and requests the display of course start notice screen (Corresponding to Operation S18 of FIG. 11).

The user, who has received the start notice of the exercise management course by processing in Operation S48, makes the control circuit 303 of the cell phone 300 execute an exercise-amount notifying application program. Therefore, the cell phone 300 starts the exercise-amount notification processing unit 313. The user sets the course-entry ID displayed on the course-start notification screen and class of exercise amount notified to the exercise management server 100 in the exercise-management processing corresponding to this course-entry ID to the exercise-amount notification processing unit 313. For example, the class of the course-entry ID and the amount of exercise, which have been set, are stored in the non-volatile memory 304 of the cell phone 300.

The exercise-amount notification processing unit 313, where the setting thereof is completed, starts accumulation processing of the measuring results by the acceleration sensor 307. The exercise-amount notification processing unit 313 calculates the amount of exercise corresponding to the predetermined class based on the accumulated measuring results, and transmits the calculation result of the exercise amount and course-entry ID to the exercise management server 100 at a predetermined time, for example once a day (corresponding to Operation S19 in FIG. 11).

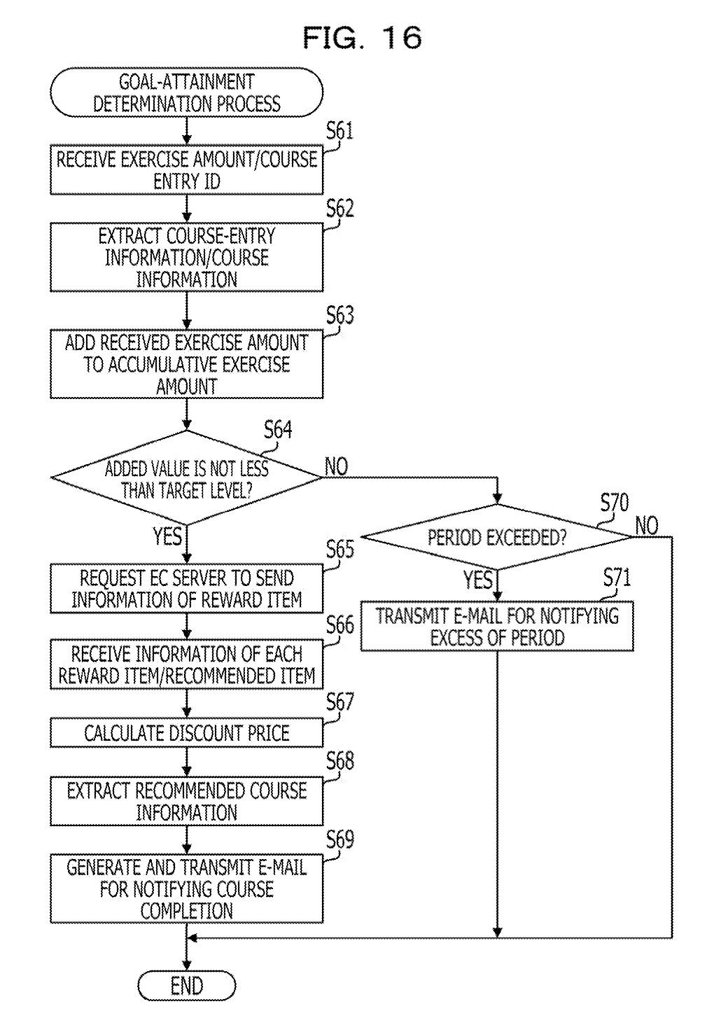

FIG. 16 is a flow chart illustrating processing of an exercise management server when enrollment in an exercise management course is accepted;

[Operation S61] The exercise-amount receiving unit 113 of the exercise management server 100 receives the exercise amount and the course-entry ID from the cell phone 300. The exercise-amount receiving unit 113 outputs the received information to the goal-attainment determination unit 112.

For example, the information received by the exercise-amount receiving unit 113 in Operation S61 may be the information transmitted from the user terminal devices other than the cell phone 300. For example, the exercise amount and the course-entry ID are input by the user's operation to PC 400 which is an example of a user terminal device. The exercise amount and course-entry ID input in the PC 400 may be transmitted to the exercise management server 100.

[Operation S62]

The goal-attainment determination unit 112 extracts the course-entry information into which the course-entry ID received from exercise-amount receiving unit 113 is registered from the user DB 121. The goal-attainment determination unit 112 searches a record corresponding to the course ID registered in the course-entry information extracted from the user DB 121 from the course DB 122. Then the goal-attainment determination unit 112 extracts the information about the exercise management course indicated on the searched record.

[Operation S63]

The goal-attainment determination unit 112 adds the exercise amount received from cell phone 300 in Operation S61 to the cumulative exercise amount registered into the course-entry information extracted from the user DB 121 in Operation S62.

[Operation S64]

The goal-attainment determination unit 112 compares the additional value calculated in Operation S63 with the target exercise amount set as the record extracted from course DB 122 in Operation S63. The goal-attainment determination unit 112 determines that the user has attained the goal when the additional value is not less than a target level. Then, the goal-attainment determination unit 112 performs processing of Operation S65. On the other hand, goal-attainment determination unit 112 performs processing of Operation S70, when an additional value is less than a target level.

[Operation S65]

When it is determined that the user has attained the goal, the goal-attainment determination unit 112 notifies the achievement of the goal to the notification-information generating unit 114. The notification-information generating unit 114 which received the notice extracts the commercial item ID of a reward item from the course-entry information extracted from the user DB 121 in Operation S62. The notification-information generating unit 114 transmits the commercial item ID of the reward item extracted from the course-entry information to the item-management unit 212 of the EC server 200, and requests the transmission of information about the reward item (corresponding to Operation S20 of FIG. 11).

[Operation S66]

The item-management unit 212 of the EC server 200 specifies the record corresponding to the commercial item ID of the reward item received from the exercise management server 100 from item DB 221. From the record specified from the item DB 221, the item-management unit 212 extracts information, including the item name, price, URL, and the like of the reward item, and transmits to the notification-information generating unit 114 of the exercise management server 100.

The item-management unit 212 extracts the commercial item ID of a recommended item from the record extracted from the item DB 221. Then the item-management unit 212 specifies the record corresponding to the commercial item ID of the recommended item from the item DB 221. The item-management unit 212 extracts information, such as item name and price, about a recommended item from the record corresponding to the commercial item ID of the recommended item. The item-management unit 212 transmits this information to the notification-information generating unit 114 of the exercise management server 100 (corresponding to Operation S21 in FIG. 11).

The notification-information generating unit 114 receives the information about a reward item and the information about recommend information from the item-management unit 212 of the EC server 200.

[Operation S67]

The notification-information generating unit 114 calculates a difference between the entry date registered in the course-entry information extracted from the user DB 121 and the present date in Operation S62. Thus, the goal achievement period is calculated. The notification-information generating unit 114 reads a period set to the record extracted from the course DB 122 in Operation S62. Then the notification-information generating unit 114 calculates the rate (achievement period rate) of a goal achievement period to the read period. The notification-information generating unit 114 reads the discount rate matched with the calculated achievement period rate with reference to the incentive DB 123. The notification-information generating unit 114 applies the discount rate read from incentive DB 123 to the price of the reward item received from EC server 200 in Operation S67, and calculates a discount price.

[Operation S68]

The notification-information generating unit 114 extracts the course ID of a recommended course from the record searched in Operation S62 from the course DB 122. The notification-information generating unit 114 specifies the record corresponding to the course ID of a recommended course from course DB 122. Then the notification-information generating unit 114 extracts information, including course name, period, exercise-type information, target level, and the like about the recommended course from the specified record.

[Operation S69]

The notification-information generating unit 114 generates an e-mail which notifies a user of completion of the exercise management course. Like the example illustrated in FIG. 14, the e-mail generated at this time describes information about a reward item, an image linked to an introduction page of the item, and the like. For example, in the e-mail document 340 of FIG. 14, linked URL matched with purchase request button 342 is set to URL about the reward item transmitted from the EC server 200 in Operation S66. The item information section 341 of e-mail document 340 describes the name and price of a commercial item as information about the reward item. When a discount price is applied in Operation S67, the item information section 341 describes a discount price and a discount rate.

The e-mail generated in Operation S69 describes the recommended item information and recommended course information. For example, in the e-mail document 340 of FIG. 14, the item selection section 343 displays the item name of the recommended item transmitted from the EC server 200 in Operation S66 etc. The course selection section 347 of the e-mail document 340 displays the course name and period about a recommended course extracted in Operation S68. The course selection section 347 displays the information about the target level based on the exercise amount class and target level about the recommended course extracted in Operation S68.

The information-notifying unit 115 transmits an e-mail generated by notification-information generating unit 114 to an e-mail address registered in a record as a destination on the network 500, where the recode includes course-entry information extracted from the user DB 121 in Operation S62. (corresponding to Operation S22 of FIG. 11).

[Operation S70]

The goal-attainment determination unit 112 determines whether the period of exercise management is exceeded based on the entry date registered into the course-entry information extracted from user DB 121 in Operation S62 and the period extracted from course DB 122 in Operation S62. The goal-attainment determination unit 112 exceeds processing of Operation S71 when it is determined that the period of exercise management has expired. On the other hand, the goal-attainment determination unit 112 ends the processing about the information received in Operation S61 when it is determined that the period of exercise management has not expired.

[Operation S71]

The goal-attainment determination unit 112 notifies that the period of the exercise management is expired to the notification-information generating unit 114. The notification-information generating unit 114 which received the notice generates an e-mail that notifies out of period. In addition, the notification-information generating units 114 deletes the course-entry information extracted from the user DB 121 in Operation S62 from the user DB 121. The information-notifying unit 115 transmits the e-mail that notifies out of period, which is generated by the notification-information generating unit 114, to an e-mail address, which is registered in the record containing the course-entry information extracted from user DB 121 in Operation S62, as a destination through the network.

When it is determined that the period of the exercise management is not expired in Operation S70, the notification-information generating unit 114 generates an e-mail which indicates the situation of the present exercise management or the like. Then, the notification-information generating unit 114 may send the e-mail to a user's destination e-mail address. The user is notified of the present situation or the like of exercise management until the exercise amount reaches a target level. The motivation of the user to exercise is kept high. As a result, the user may be more likely to purchase a reward item.

In the second embodiment as described above, the user is notified of the information about a reward item registered in advance when the user's exercise amount reaches a target level. It may prevent that a user forgets the purchase of a reward item. The user may be more likely to purchase a reward item. Furthermore, the earlier the user attains the goal, the more the selling price of a reward item may be lowered. Thus, the user's motivation for reaching the goal may be increased. As a result, sales of commercial items may be further promoted.

When user's exercise amount reaches a target level, a user is also provided with information which recommends entry to a new exercise management course and recommends the purchase of a new commercial item. Thus, it becomes possible to increase the probability that the user will make a new commercial item a reward item, and will join an exercise management. As a result, sales of commercial items are further promoted.

In the above second embodiment, the user is provided with incentive by the way of changing a discount rate of reward item price depending on the speed of attaining the goal. However, another way of providing the user with incentive, the discount rate of a reward item price may be changed according to the severity of an intended goal. For example, in the above second embodiment, a severity of a goal is previously known for every exercise management course registered in the course DB 122. Therefore, the discount rate is set up for every exercise management course to the course DB 122. The user who finished the exercise management course is allowed to apply the discount rate corresponding to the finished exercise management course to the registered reward item price. For example, when the user can set up a target exercise amount, a discount rate may be changed according to the size of a target level.

Furthermore, as another example of providing the user with insensitive depending on the speed of attaining the goal or the severity of the intended goal, there is also a method of notifying another commercial item which the user had not registered as a reward item, and recommending the purchase of the notified commercial item to the user who attained the goal. At this time, the discount rate according to the speed of attaining a goal, the severity of the intended goal or the like may be applied to the prices of other notified commercial items.

### Third Embodiment

In the above second embodiment, the user of the cell phone 300 selected the reward item from commercial items managed by the EC server 200 through the Web site offered by the exercise management server 100. On the other hand, in the following third embodiment, the user who was browsing the Web site of EC server 200 selects a reward item from commercial items managed by the EC server 200, and enables it to simply join to an exercise management course provided by the exercise management server 100.

The device configuration of the computer system and the fundamental functions of the respective devices according to the third embodiment are the same as those of second embodiment. Therefore, the third embodiment will be described using the same reference numerals as those of FIG. 5 and FIG. 10.

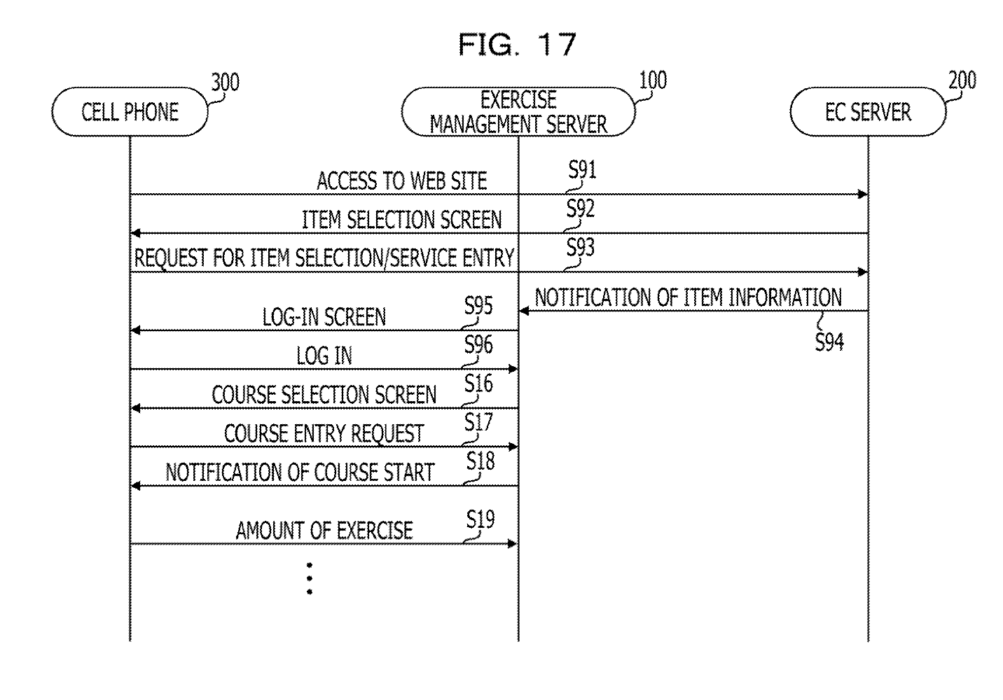

FIG. 17 is a sequence diagram illustrating processing among apparatuses in a computer system according to a third embodiment; In FIG. 17, the same processing as one illustrated in FIG. 11 will be represented by the same “Operation No.”

A user who intends to utilize item-selling service provided by the EC server 200 starts, for example, the web browser of the cell phone 300, and browses the Web site of EC server 200. The Web-page browse processing unit 311 of cell phone 300 accesses the Web site provided by the EC server 200 according to a user's input operation (Operation S91).

The accessed sale-processing unit 211 of the EC server 200 reads information about item ID, item name, price, and the like of a plurality of commercial items from item DB 221 through the item-management unit 212. Based on the information on the commercial item read from item DB 221, the sale-processing unit 211 generates the Web page of an item-selection screen where the user is allowed to select an item to be purchased, and transmits Web-page data to cell phone 300 (Operation S92). The Web-page browse processing unit 311 of the cell phone 300 displays the Web page of an item-selection screen on the display 306a based on the received data.

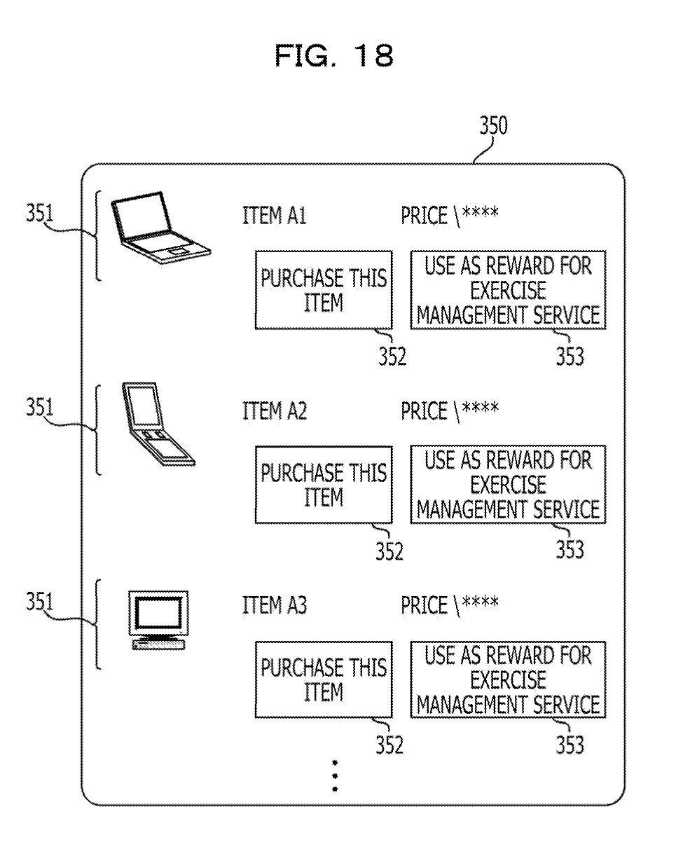

Here, FIG. 18 is a diagram illustrating an exemplary display of an item-selection screen.

The item-selection screen 350 illustrated in FIG. 18 is an example of the screen displayed on the display 306a of the cell phone 300 according to the processing of Operation S92 of FIG. 17. The item-selection screen 350 has an item information display unit 351 that displays the information about each commercial item which can be individually purchased. Each of item information display units 351 displays the item name, price, and the like of a commercial item.

By corresponding to each of the item information display units 351, purchase request button 352, and service subscription request button 353 are displayed. The user can demand the purchase of the commercial item corresponding to the selected purchase request button 352 from the EC server 200 by performing the selection operation to the purchase request button 352 corresponding to a desired item among the displayed commercial items.

A service-entry request button 353 requests entry to the exercise management service provided by the exercise management server 100. The service-entry request button 353 makes it possible to register the commercial item corresponding to the service-entry request button 353 as a reward item. The user performs the selection operation to the service-entry request button 353 corresponding to one of commercial items. Then, the web-page browse processing unit 311 of the cell phone 300 transmits commercial item ID of a selected item while requesting an entry in exercise management service from the EC server 200.

Referring back to FIG. 17, the description will be made. If the subscription request and commercial item ID to the exercise management service from cell phone 300 are transmitted (Operation S93) and sale-processing unit 211 of EC server 200 receives these information, the sale-processing unit 211 will notify commercial item ID received from the cell phone 300 to the service reception unit 111 of the exercise management server 100, and will demand execution of a service subscription acceptance process (Operation S94).

The service reception unit 111 which has received commercial item ID requests the display of the Web page for login from cell phone 300 (Operation S95). The user enters login information, such as user ID and a password, into predetermined regions in the Web page for login, and performs a long-in request operation. The Web-page browse processing unit 311 transmits input login information to the exercise management server 100, and requests login (Operation S96). The service reception unit 111 of exercise management server 100 performs user authentication based on received log-in information.

Before the EC server 200 displays an item-selection screen on the cell phone 300 in Operation S93, it accepts a user's log-in information from cell phone 300, and may perform user authentication. In this case, the EC server 200 transmits the log-in information containing user ID to exercise management server 100 in Operation S94. The service reception unit 111 of exercise management server 100 can omit login processing of Operation S95 and S96 by performing user authentication using the log-in information which received from the EC server 200.

The service reception unit 111 of exercise management server 100 certificates a user correctly. Then, one course-entry information is generated in the record corresponding to the user who logged in among the records of user DB 121. Into the generated course-entry information, a unique course-entry ID and commercial item ID which received from EC server 200 are registered. Then, processing after Operation S16 of FIG. 11 is performed between the exercise management server 100 and the cell phone 300. Then, entry procedure to an exercise management course is performed, and a participating exercise management course is started.

In the above third embodiment, the user who is browsing the Web site provided by the EC server 200 can register into exercise management server 100 the commercial item currently sold in the Web site as a reward item by easy operation, and a desired exercise management course can be joined now. Therefore, sales of commercial items in the EC server 200 can be promoted.

### Fourth Embodiment

In a computer system according to a fourth embodiment, furthermore, a third person other than those who actually exercise add a mechanism for confirming achievement of the goal and approval of reward item purchase to the computer system according to the second embodiment. The acknowledger who accepts the purchase of a reward item may also perform selection of an exercise management course. For example, an acknowledger may be a family of those who exercise or the like. An acknowledger accesses the exercise management server 100 through a terminal device. According to the following fourth embodiment, for example, an acknowledger may access the exercise management server 100 through PC 400.

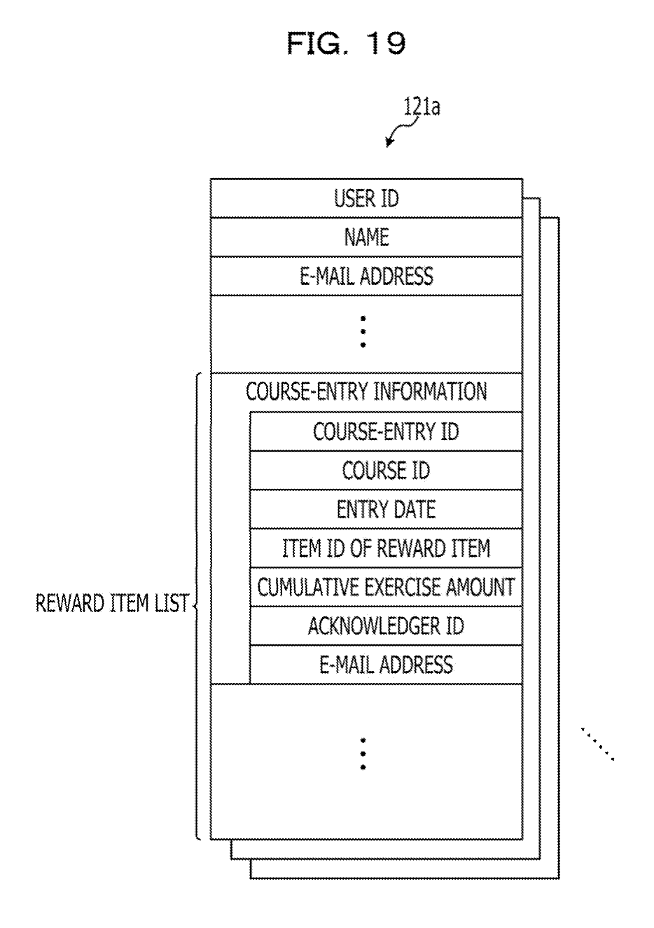

The device configuration of the computer system and the fundamental functions of the respective devices according to the fourth embodiment are the same as those of second embodiment. Therefore, the fourth embodiment will be described using the same reference numerals as those of FIGS. 2 to 5 and FIG. 10. However, in the exercise management server 100 of the fourth embodiment, a user DB 121a illustrated in FIG. 19 is provided instead of the user DB 121.

FIG. 19 is a diagram illustrating exemplary data stored in a user DB.

To the user DB 121a, a record is registered for every user in a manner similar to the second embodiment. Course-entry information is registered in each record together with user information, such as user ID, a user's name, and a user's e-mail address. Each record can register a plurality of course-entry information. Like the second embodiment, unique course-entry ID, the course ID of a user-participating exercise management course, the entry date to an exercise management course, commercial item ID of a reward item, and cumulative exercise amount are registered in each course entry information.

In each course-entry information, an acknowledger ID for identifying acknowledger and an acknowledger's e-mail address are registered. Information for identifying the acknowledger may be acknowledger ID or the name of an acknowledger or the like. The e-mail address of acknowledger ID and the acknowledger may be set up to each user's record but not to each course entry information.

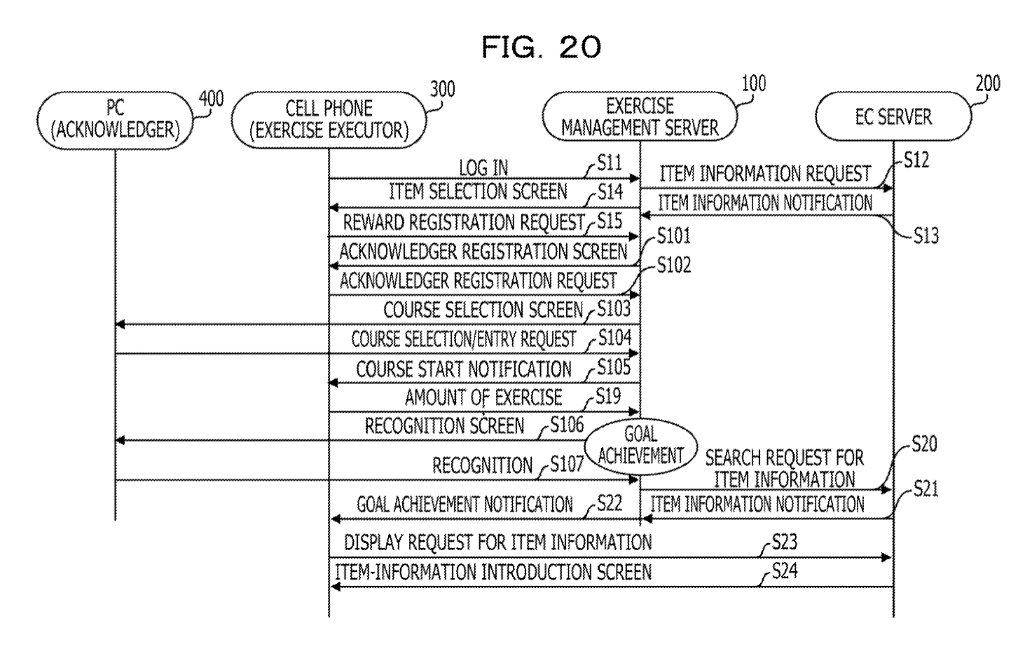

FIG. 20 is a diagram illustrating a sequence diagram illustrating processing among apparatuses in a computer system according a fourth embodiment. In FIG. 20, the same processing as one illustrated in FIG. 11 will be represented by the same “Operation No.”

In processing of FIG. 20, processing of Operation S11 to S15 is the same as that of FIG. 11. That is, a user who intends to join an exercise management course (hereinafter, called an exercise executor) logs in to exercise management server 100 through the Web page for login which exercise management server 100 offers (Operation S11). The service reception unit 111 of exercise management server 100 which received login acquires the information on a commercial item through item-management unit 212 of EC server 200 (Operation S12, S13), and displays the Web page of an item-selection screen on cell phone 300 (Operation S14). The exercise executor performs operation which selects a desired item from an item-selection screen, and Web-page browse processing unit 311 of cell phone 300 transmits commercial item ID of a selected item to exercise management server 100 (Operation S15).

It is requested that service reception unit 111 of exercise management server 100 which received commercial item ID should display the Web page of an acknowledger registration screen to cell phone 300 (Operation S101). An acknowledger registration screen is displayed, and an exercise executor inputs an acknowledger's information (acknowledger ID and an e-mail address), and, as for display 306a of cell phone 300, performs request-to-send operation to exercise management server 100. The Web-page browse processing unit 311 of cell phone 300 transmits an input acknowledger's information to exercise management server 100, and requests the registration to user DB 121 (Operation S102).

Service reception unit 111 of exercise management server 100 generates one course-entry information in the record corresponding to the exercise executor logged in by Operation S11 among the records of user DB 121a. The service reception unit 111 registers a unique course-entry ID and the information of the acknowledger who received from cell phone 300 with commercial items ID and Operation S102 received from EC server 200 by Operation S102 into the generated course-entry information. The acknowledger's information registered into course-entry information may be matched in advance and set as the record of user DB 121, and the registration receptionist processing using the acknowledger registration screen of Operation S101 and S102 can be omitted in this case.

Next, PC 400 used by an acknowledger displays the Web page of the selection screen of an exercise management course in response to the request from service reception unit 111 (Operation S103). More specifically, for example, the service reception unit 111 makes the information-notifying unit 115 transmits an e-mail addressed to the third person registered in the course entry information in Operation S102. For example, this e-mail contains the linked image to the Web page for selection of an exercise management course. When the e-mail addressed to the acknowledger is received by PC 400, the acknowledger performs the selection operation to the linked image on the received e-mail. According to this selection operation, the Web-page browse processing unit (not shown) of PC 400 accesses the linked URL on the exercise management server 100. The service reception unit 111 of exercise management server 100 receiving access extracts the information about a plurality of exercise management courses from course DB 122, and the Web page for selection of an exercise management course is generated based on the extracted information, and the Web page is displayed on PC 400.

The acknowledger performs subscription request operation to the exercise management course which selected by performing the selection operation to a desired exercise management course from the exercise management courses by which the list display was carried out to the Web page for selection of the exercise management course. The Web-page browse processing unit of PC 400 transmits the course ID of the exercise management course selected by the acknowledger according to subscription request operation to exercise management server 100, and the entry to the exercise management course corresponding to the course ID which transmitted is requested (Operation S104).

The service reception unit 111 of exercise management server 100 which received the subscription request registers the course ID which the acknowledger selected as the course-entry information generated after Operation S102. In addition, the present date is registered into the same course-entry information as an entry date, and initial value “0” is registered into it as cumulative exercise amount.

When the above processing is completed, the service reception unit 111 generates the Web page that notifies the user of the start of the course in which entry was requested. Then the service reception unit 111 transmits the data of the Web page to the cell phone 300 (Operation S105). In the Web page which is transmitted at this time, the course-entry ID registered in the course-entry information after execution of Operation S102 is described. The contents of the exercise management course selected by the acknowledger is also described. The contents of the selected exercise management course include the information which shows the class of the exercise amount which should transmit to exercise management server 100 from cell phone 300.

The exercise management course is selected by the acknowledger in the above processing. The exercise management course may be selected by the exercise executor.

Next, the processing after an exercise executor joins an exercise management course will be described. The exercise executor which received the start notice of the exercise management course makes control circuit 303 of cell phone 300 execute an exercise-amount notifying application program. Therefore, the cell phone 300 starts the exercise-amount notification processing unit 313. The exercise executor sets the class of the course-entry ID and exercise amount which were displayed on the course start notice screen as exercise-amount notification processing unit 313.

The exercise-amount notification processing unit 313, where the setting thereof is completed, starts accumulation processing of the measuring results by the acceleration sensor 307. Then the exercise-amount notification processing unit 313 calculates the exercise amount corresponding to the class set up, for example based on the measuring result accumulated in 1 time per of the decided time day, and transmits the calculation result and course-entry ID of an exercise amount to exercise management server 100 (Operation S19). Repeat execution of the transmitting processing of the exercise amount by exercise-amount notification processing unit 313 and a course-entry ID is carried out until an exercise amount reaches a target level. Alternatively, repeat execution is carried out until the period of the exercise-management processing corresponding to a course-entry ID expires.

Exercise-amount receiving unit 113 of exercise management server 100 receives the exercise amount and course-entry ID which were transmitted from cell phone 300 like second embodiment, and outputs them to goal-attainment determination unit 112. Goal-attainment determination unit 112 determines the whether the amount of exercise has reached the target level of an exercise executor by processing shown in Operation S62 to S64 of FIG. 16. Here, when the exercise amount has reached the target level, goal-attainment determination unit 112 notifies what the target attained to notification-information generating unit 114.

The notification-information generating unit 114 which received the notice sends a request to an acknowledger's terminal device (here PC 400) (device registered into the course-entry information corresponding to the course-entry ID which received from cell phone 300). Then the acknowledger's terminal device displays the Web page (Web page for recognition) of a recognition screen (Operation S106). More, for details, notification-information generating unit 114 reads an acknowledger's e-mail address from course-entry information, and transmits the e-mail which notifies goal achievement by making the read e-mail address into an address, for example. The linked image which links this e-mail to the Web-page URL for recognition is contained.

When the e-mail addressed to an acknowledger is received by PC 400, an acknowledger performs the selection operation to the linked image on the received e-mail, and the Web-page browse processing unit of PC 400 is accessed at the linked URL on exercise management server 100 according to this selection operation. The service reception unit 111 of exercise management server 100 which received access sends a request to PC 400. This request displays the Web page for recognition on PC 400. Thus, the display 306a of PC 400 displays the Web page for recognition.

The Web page for recognition describes the fact that the exercise executor attains the goal of the exercise management course. An acknowledger performs recognition operation to the Web page for recognition, after checking the contents of the Web page for recognition. The Web-page browse processing unit of PC 400 notifies recognition to exercise management server 100 according to recognition operation (Operation S107).

The service reception unit 111 of exercise management server 100 notifies notification-information generating unit 114 that the notice of recognition was received. The notification-information generating unit 114 transmits commercial item ID of the reward item registered into the course-entry information corresponding to the course in which the goal was attained to EC server 200, and requests search of item information (Operation S20). Henceforth, between exercise management server 100, EC server 200, and cell phone 300, the same processing as Operation S21-S24 of FIG. 11 is performed.

According to the fourth embodiment described above, when the goal in an exercise management course is attained, after acknowledgers other than an exercise executor are notified of that and recognition by an acknowledger is acquired, an exercise executor can perform the purchase procedure of a reward item. In such processing, since the track record in the exercise management course by an exercise executor will be advertised to an acknowledger by notifying an acknowledger of having attained the goal, an exercise executor can raise the motivation which attains the goal. Since the track record in an exercise management course is strongly appeasable with an acknowledger because it is made to perform selection of an exercise management course by an acknowledger, the motivation of an exercise executor can be raised further. As a result, the probability that an exercise executor will purchase a reward item becomes high, and sale of a commercial item is promoted.

### Fifth Embodiment

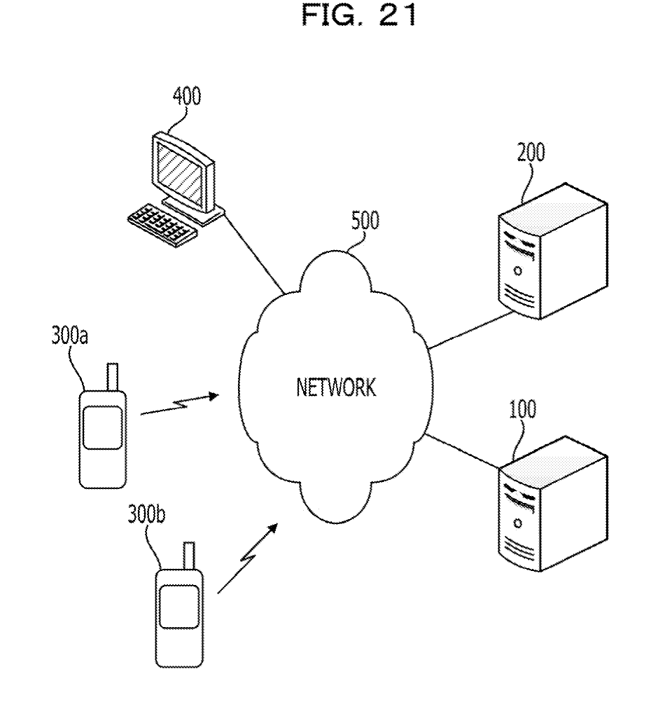

FIG. 21 is a diagram illustrating an exemplary system configuration of a computer system according to a fifth embodiment.

In a computer system according to a fifth embodiment, like the fourth embodiment described above, in addition to an acknowledger performing selection of an exercise management course, and recognition at the time of goal achievement, a plurality of exercise executors join one exercise management course, and it makes it possible to compete for goal achievement by a plurality of exercise executors. In the following description, for example, a case where two persons' exercise executor join one exercise management course will be described. In FIG. 21, cell phones 300a and 300b are user terminal devices which two persons' exercise executor uses, respectively. PC 400 shall be a terminal device used by the acknowledger like a fourth embodiment.

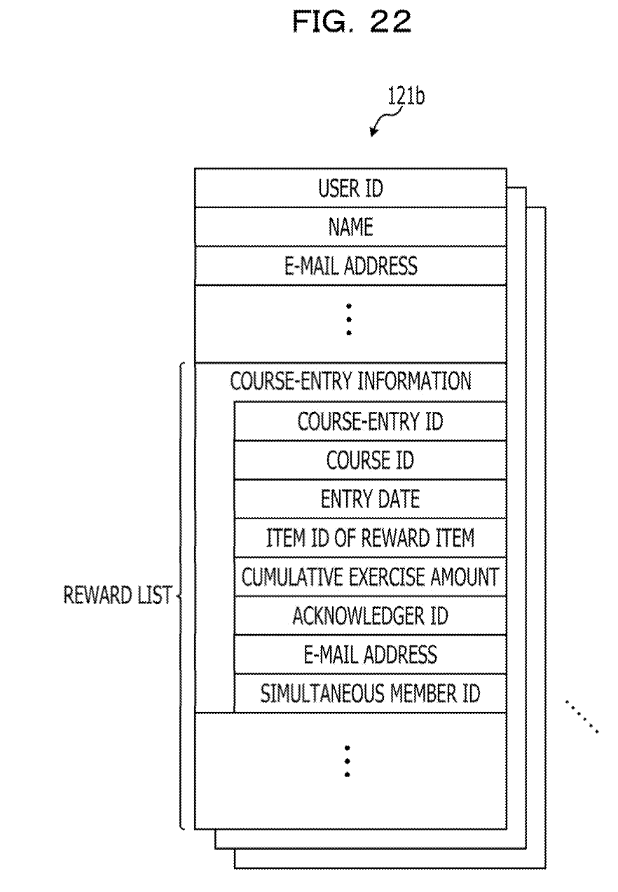

Cell phones 300a and 300b of the fundamental configuration of the processing function included, respectively are the same as that of FIG. 10. In the following description, processing functions of the respective cell phones 300a and 300b will be described using the same reference numerals as those in FIG. 10. Exercise management server 100 and EC server 200 have the same fundamental functions as those of FIG. 5. In the following description, the processing functions of the exercise management server 100 and the EC server 200 will be also described using the same reference numerals as those in FIG. 5, respectively. However, in the exercise management server 100 of the fifth embodiment, a user DB 121b illustrated in FIG. 22 is used instead of the user DB 121.

FIG. 22 is a figure showing the example of the data stored by user DB.

To the user DB 121b, a record is registered for every user in a manner similar to the second embodiment. Course-entry information is registered in each record together with user information, such as user ID, a user's name, and a user's e-mail address. Each record can register a plurality of course-entry information. Like the second embodiment, unique course-entry ID, the course ID of a user-participating exercise management course, the entry date to an exercise management course, commercial item ID of a reward item, and cumulative exercise amount are registered in each course entry information.

As for each course-entry information, an acknowledger ID for identifying acknowledger and an acknowledger's e-mail address are registered like a fourth embodiment. Simultaneous member ID which is the user ID of other users (exercise executor) whom each course-entry information joined simultaneously is registered. Each course-entry information can also register a plurality of simultaneous member IDs. Simultaneous member ID may be registered only into the course-entry information in a representative's record among a plurality of exercise executors which joined the exercise management course simultaneously, for example.

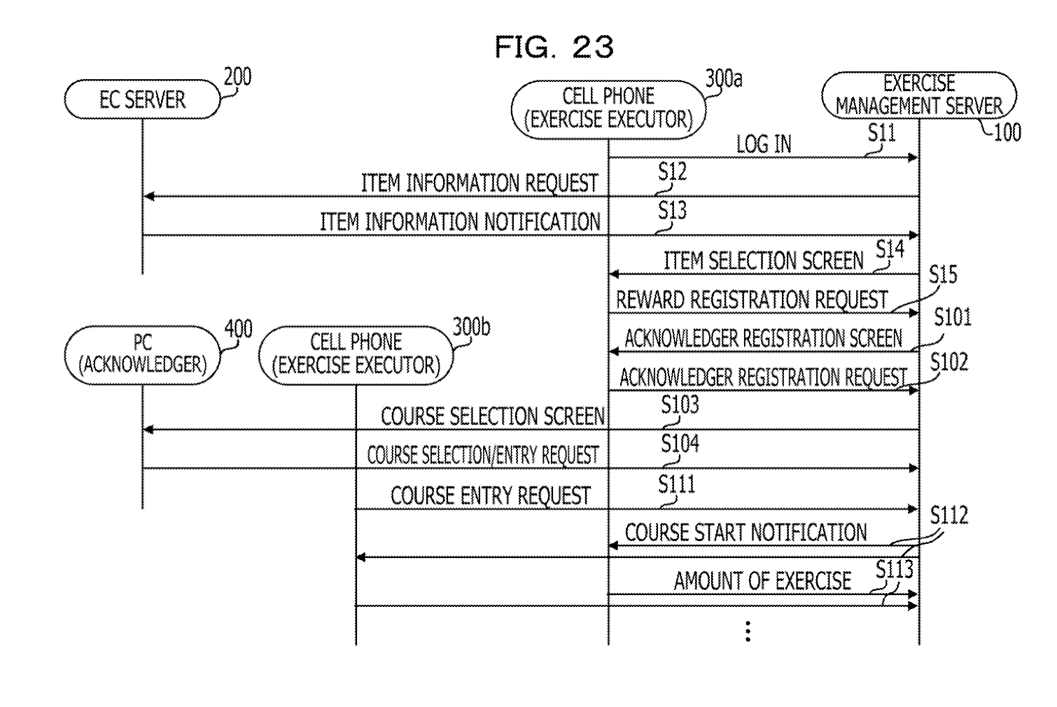

FIG. 23 is a sequence diagram illustrating processing until an exercise management course is started in the fifth embodiment. In FIG. 23, the same processing as that of FIGS. 11 and 20 is described using the same reference numerals as those of FIGS. 11 and 20.

First, one (hereafter called a first exercise executor) of two exercise executors logs in to exercise management server 100 through cell phone 300a to register a reward item. The first exercise executor requests registration of a reward item through cell phone 300a. Then, the service reception unit 111 of exercise management server 100 accepts selection and the subscription request of an exercise management course from an acknowledger. The above processing is the same as the processing shown in Operation S11 to S15 of FIGS. 20, S101 to S104.

Next, the exercise management server 100 accepts the subscription request to the exercise management course from another exercise executor (hereafter called a second exercise executor) (Operation S111). For example, a second exercise executor asks an acknowledger to teach the course-entry ID of the course-entry information registered into user DB 121b according to processing of Operation S15. A course-entry ID may be notified by a Web page or the e-mail from exercise management server 100 to a first exercise executor during a period from processing of Operation S102 to Operation S111. In this case, the second exercise executor may ask the first exercise executor to teach a course-entry ID from the first exercise executor.

For example, the second exercise executor operates cell phone 300b, and browses the Web page for a course addition entry which exercise management server 100 offers. The second exercise executor inputs into the predetermined region in the Web page for a course addition entry the course-entry ID taught from user ID, and a second exercise executor's own acknowledger or first exercise executor, and performs operation of requesting transmission to the exercise management server 100. The Web-page browse processing unit 311 of cell phone 300b transmits input user ID and a course-entry ID to exercise management server 100 according to operation by the second exercise executor.

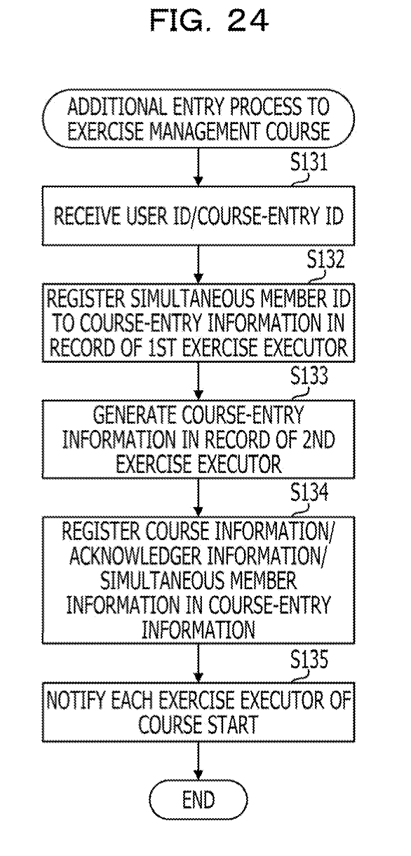

The service reception unit 111 of exercise management server 100 is registered into user DB 121b by making the second exercise executor into a simultaneous member based on the user ID and the course-entry ID which received from cell phone 300b. The registration processing at this time will be described with reference to FIG. 24. After registration processing completing to user DB 121b, the notification-information generating unit 114 of exercise management server 100 makes the information-notifying unit 115 transmit an e-mail that indicates starting an exercise management course to each of e-mail addresses of the first exercise executor and the second exercise executor (Operation S112). Henceforth, cell phones 300a and 300b start measurement processing of an exercise amount, and transmit the calculation result of an exercise amount to exercise management server 100 at the fixed time (Operation S113).

FIG. 24 is a flowchart illustrating processing for additional enrollment in an exercise management course by an exercise management server.

[Operation S131]

The service reception unit 111 of exercise management server 100 receives the user ID and the course-entry ID of a second exercise executor from the cell phone 300b (corresponding to Operation S111 of FIG. 23).

[Operation S132]

The service reception unit 111 specifies the course-entry information corresponding to the course-entry ID which received by Operation S131 from user DB 121b. The service reception unit 111 registers the user ID of the second exercise executor which received by Operation S131 as a simultaneous member ID to the specified course-entry information. The course-entry ID specified at this time corresponds to the course-entry information newly generated by user ID according to processing of Operation S15 of FIG. 23.

[Operation S133]

The service reception unit 111 specifies the record corresponding to the user ID of the second exercise executor which received by Operation S131 from user DB 121b, and newly generates course-entry information about the specified record. The service reception unit 111 registers the same value as the course-entry ID registered into the course-entry information specified by Operation S132 as a course-entry ID of the generated course-entry information.

[Operation S134]

The service reception unit 111 reads information from the course-entry information specified by Operation S132. The information includes a course ID, an entry date, commercial item ID of a reward item, acknowledger ID, and an e-mail address of the acknowledger. The service reception unit 111 registers each read information into the course-entry information generated by Operation S133. The service reception unit 111 sets initial value “0” as the course-entry information generated by Operation S133 as cumulative exercise amount. In this Operation S134, registration of information other than cumulative exercise amount is not indispensable.

[Operation S135]

The service reception unit 111 requests transmission of the e-mail which reports that exercise management service is started from notification-information generating unit 114. Notification-information generating unit 114 which received the request generates the e-mail which notifies a service start. The class of the course-entry ID which received this e-mail by Operation S131, and the exercise amount to which it was set in the participating exercise management course is indicated.

The e-mail address (e-mail address of a first exercise executor) registered into the record containing the course-entry information which specified notification-information generating unit 114 by Operation S132. The e-mail address (e-mail address of an exercise executor [being second]) registered into the record specified by Operation S113 is notified to information-notifying unit 115, and transmission of the generated e-mail is requested. Information-notifying unit 115 transmits the e-mail generated by notification-information generating unit 114 on network 500 by making each e-mail address of first and second exercise executors into an address.

The first and second exercise executors which received the start notice of the exercise management course sets up the class of an exercise amount like the case of a fourth embodiment to exercise-amount notification processing unit 313 of cell phones 300a and 300b which each uses by processing of Operation S135. Exercise-amount notification processing unit 313 of each cell phone 300a and 300b which a setup completed starts accumulation processing of the measuring result by acceleration sensor 307. At the decided time, each exercise-amount notification processing unit 313 calculates an exercise amount based on the accumulated measuring result, and transmits the calculation result of an exercise amount to exercise management server 100 with user ID and a course-entry ID. (corresponding to Operation S113 of FIG. 23)

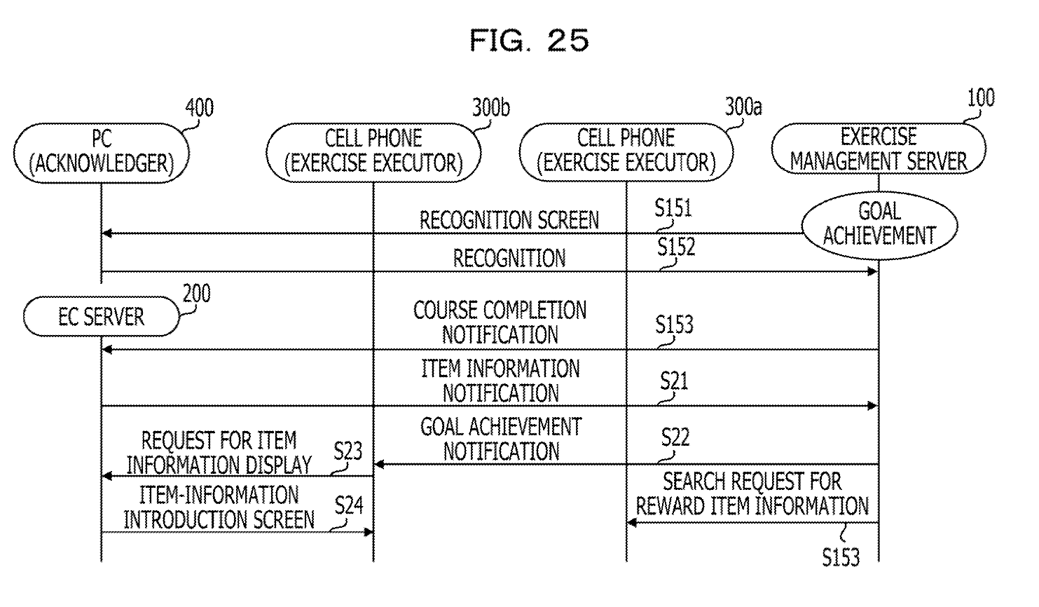

Next, FIG. 25 is a sequence diagram showing the processing after the exercise management course was started in a 5th embodiment.

Goal-attainment determination unit 112 of exercise management server 100 determines a whether the amount of exercise has reached the target level within the specified period through exercise-amount receiving unit 113 based on the exercise amount transmitted from each of cell phones 300a and 300b. Here, the exercise amount of the exercise executor [being second] which uses cell phone 300b should reach the target level within the specified period, for example.

Goal-attainment determination unit 112 notifies notification-information generating unit 114 that the exercise executor [being second] attained at the target. Notification-information generating unit 114 which received the notice reads an acknowledger's e-mail address from the course-entry information corresponding to the exercise management course by which the goal was attained. Here, the course-entry information corresponding to the exercise management course by which the goal was attained is the course-entry information specified by Operation S132 of FIG. 24, or the course-entry information generated by Operation S133. Since the course-entry ID with such same course-entry information is given, notification-information generating unit 114 can specify such course-entry information based on the course-entry ID which received with the exercise amount from any of cell phones 300a and 300b.

Goal-attainment determination unit 112 is requested of information-notifying unit 115 so that the e-mail address of the acknowledger who read the e-mail which notifies goal achievement from course-entry information may be transmitted as an address. The linked image which links this e-mail to URL of the Web page (Web page for recognition) of a recognition screen is contained. Information-notifying unit 115 transmits an e-mail according to the request from notification-information generating unit 114.

When the e-mail addressed to an acknowledger is received by PC 400, an acknowledger performs the selection operation to the linked image on the received e-mail, and the Web-page browse processing unit of PC 400 is accessed at the linked URL on exercise management server 100 according to this selection operation. Requesting for PC 400 that service reception unit 111 of exercise management server 100 which received access should display the Web page for recognition, thereby, display 306a of PC 400 displays the Web page for recognition.

It is indicated that the exercise executor [that the Web page for recognition is second] attained the goal in an exercise management course. An acknowledger performs recognition operation to the Web page for recognition, after checking the contents of the Web page for recognition. The Web-page browse processing unit of PC 400 notifies recognition to exercise management server 100 according to recognition operation. (Operation S152) A course-entry ID is also given to the information notified to exercise management server 100 at this time.

The service reception unit 111 of exercise management server 100 notifies notification-information generating unit 114 that the notice of recognition was received with the course-entry ID to which it was given by the notice of recognition. The notification-information generating unit 114 transmits commercial item ID of the reward item registered into the course-entry information corresponding to the course-entry ID notified from service reception unit 111 to EC server 200, and requests search of item information (Operation S153).

Henceforth, between exercise management server 100, EC server 200, and cell phone 300b, the same processing as Operation S21 to S24 of FIG. 11 is performed. That is, the item-management unit 212 of EC server 200 searches item DB 221 using commercial item ID of the reward item which received from notification-information generating unit 114 of exercise management server 100. The item-management unit 212 of EC server 200 extracts information, including an item name, a price, URL, and the like, which correspond to the reward item. Furthermore, the item-management unit 212 extracts commercial items ID of the recommended item registered into the record of the reward item, and also extracts information, including the item name corresponding to extracted commercial item ID, price, and so on. The item-management unit 212 transmits the information extracted from the item DB 221 to the notification-information generating unit 114 of the exercise management server 100 (Operation S21).

The notification-information generating unit 114 of the exercise management server 100 extracts the course ID of the recommended course in the record with reference to the record of course DB 122 corresponding to the exercise management course on which the user attained the goal. The notification-information generating unit 114 extracts the recommended course information with reference to the record of course DB 122 corresponding to the extracted course ID.

The notification-information generating unit 114 requests the information-notifying unit 115 to send a notice of goal achievement containing the information received from the EC server 200 and the recommended course information extracted from the course DB 122 to an e-mail address of the second exercise executor. At this time, notification-information generating unit 114 indicates a discount, a discount price, and a discount rate for the selling price of a reward item in notice of goal achievement according to the period which the user required by goal achievement based on the information about incentive DB 123. The information-notifying unit 115 transmits a notice of goal achievement including the information received from the notification-information generating unit 114 as an e-mail where the e-mail address of the second exercise executor is used as a destination address (Operation S22).

The e-mail transmitting/receiving unit 312 of the cell phone 300b receives e-mail addressed to the second exercise executor. While it is indicated that the received e-mail attained the goal, the information about a reward item is indicated. An exercise executor [being second] is browsing an e-mail, and checks the information about a reward item. An exercise executor [being second] accesses EC server 200 based on the information indicated to the e-mail, can check the details of an information about the reward item, or can perform the purchase procedure of (Operation S23, S24), and a reward item.

On the other hand, notification-information generating unit 114 of exercise management server 100 sends a request to information-notifying unit 115. In response to the request, the Information-notifying unit 115 transmits the notice information which notifies addressing to an e-mail address of a first exercise executor that the exercise management course was completed when the second exercise executor attained at the target. The information-notifying unit 115 transmits the e-mail which notifies the end of a course to addressing to an e-mail address of a first exercise executor according to the request from notification-information generating unit 114 (Operation S153).

In the fifth embodiment described above, a plurality of exercise executors obtain the same target exercise amount, and compete achievement of a target. The information about the reward item was notified to the exercise executor which attained the goal early most, and purchase of a reward item was enabled. By such processing, the exercise executor can exercise enjoying itself and can maintain now the buying motivation of the reward item of each exercise executor reasonable. As a result, sales of commercial items can be promoted more effectively.

In the above fifth embodiment, when one of exercise executors attained the goal, after the acknowledger accepted, the information about the reward item is notified to the exercise executor which attained the goal. For example, it is also possible to change so that an information about the reward item may be notified without performing recognition processing of an acknowledger. It may be made for not an acknowledger but one of exercise executors to select target exercise amount.

In the processing of the fourth and fifth embodiment, as described in the third embodiment, an exercise management course may be attended from the Web site offered by the EC server 200.

In the processing functions of the respective devices in the above embodiments may be realized by a computer. In this case, a program in which the contents of processing of the function for each device is provided. The execution of the program in the computer allows the above processing function to be realized on the computer. The programs that describe the contents of processing may be stored in a recording media which are readable by the computer. Examples of the recording medium-readable by the computer include a magnetic storage medium, an optical disc, a magneto-optical recording medium, and a semiconductor memory. Examples of magnetic storage devices include a hard disk drive (HDD), a flexible disk (FD), and a magnetic tape. Examples of the optical disc include DVD, DVD-RAM, and CD-ROM/RW. Examples of the magneto-optical recording medium include MO (Magneto-Optical disk).

To distribute the programs, for example, transportable recording media, such as DVD and CD-ROM, storing such programs are commercially available. Furthermore, the programs may be stored in the storage device of a server computer in advance and the programs may be then transferred from the server computer the network to other computers through network.

A computer that executes a program stores the program stored in a transferred from a transportable recording medium or a program transferred from a server computer. Then, the computer reads the program from its storage device and then executes processing according to the program. Alternatively, the computer may directly read the program out of the transportable recording medium. In addition, the computer may execute plural kinds of processing according to the respective programs successively transferred and received from the server computer connected through the network.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An exercise management apparatus, comprising:
a storage unit that stores information that identifies an item selected by a user and a target level of an amount of exercise determined by the user;
a determination unit that receives the amount of exercise measured according to exercise by the user and determining whether the received amount of exercise has reached the target level stored in the storage unit; and
a notification unit that transmits notification information including information about the item stored in the storage unit to the user through a network when the determination unit determines that the received amount of exercise has reached the target level.

2. The exercise management apparatus according to claim 1, wherein
the notification information includes guidance information for introducing a purchase procedure for the item.

3. The exercise management apparatus according to claim 1, wherein
the notification information includes incentive information about the selected item to be given to the user in response to a state until the received amount of exercise reaches the target level.

4. The exercise management apparatus according to claim 3, wherein
the notification unit changes the contents of the incentive information in response to a period until the received amount of exercise reaches the target level or in response to the target level.

5. The exercise management apparatus according to claim 3, wherein
the incentive information is a discount rate of a price of the selected item.

6. The exercise management apparatus according to claim 1, wherein
the notification information includes information about another commercial item which is recommended for purchase by the user.

7. The exercise management apparatus according to claim 6, wherein
the notification information includes, as information about another item, guidance information that guides the user to store another item in the storage unit as a new item, while guiding the user to determine a new target level of the amount of exercise.

8. The exercise management apparatus according to claim 1, wherein
the notification information includes a recommended target level or a recommended target level range which is recommended next for the user to store in the storage unit.

9. The exercise management apparatus according to claim 8, wherein
the notification information includes guidance information for guiding the user to store a new target value based on the recommended target value or the recommended target value range in the storage unit and select another item as a new item to be stored in the storage unit.

10. The exercise management apparatus according to claim 1, wherein
the storage unit stores the information about the item and the target value corresponding to the information in common for a plurality of users,
the determining unit receives the amount of exercise of each of the plurality of users through a network and determines whether the amount of exercise of each user has reached the target level, and
the notification unit transmits the notification information so as to notify one of the pluralities of users of the information about the item when the determination unit determines that the amount of exercise of the one user has reached the target level.

11. The exercise management apparatus according to claim 1, wherein
the notification unit transmits approval request information for requesting approval of notifying the information about the item to an acknowledger through a network when the determination unit determines that the received amount of exercise has reached the target level, and
the notification unit transmits the notification information when the acknowledger receives approval information that indicates that the acknowledger has approved in response to the approval request information.

12. A method for exercise management performed by a computer, the method comprising:
storing information for identifying an item selected by a user and a target level of an amount of exercise determined by the user in a storage unit;
receiving the amount of exercise measured according to exercise by the user;
determining whether the received amount of exercise has reached the target level stored in the storage unit; and
transmitting notification information including information about the item stored in the storage unit to the user through a network when it is determined that the received amount of exercise has reached the target level.

13. The method according to claim 12, wherein
the notification information includes guidance information for introducing a purchase procedure for the item.

14. The method according to claim 12, wherein
the notification information includes incentive information about the selected item to be given to the user in response to a state until the received amount of exercise reaches the target level.

15. The method according to claim 12, wherein
the notification information includes information about another commercial item which is recommended for purchase by the user.

16. The method according to claim 15, wherein
the notification information includes, as information about another item, guidance information that guides the user to store another item in the storage unit as a new item, while guiding the user to determine a new target level of the amount of exercise.

17. The method according to claim 12, wherein
the notification information includes a recommended target level or a recommended target level range which is recommended next for the user to store in the storage unit.

18. The method according to claim 12, wherein
the information about the item and the target value corresponding to the item is stored in the storage unit in common for a plurality of users,
determining whether the amount of exercise has reached the target level includes receiving the amount of exercise of each of the plurality of users through a network and determining whether the amount of exercise of each user has reached the target level, and
transmitting notification information includes transmitting the notification information so as to notify one of the plurality of users of the information about the item when it is determined that the amount of exercise of the one user has reached the target level.

19. The method according to claim 12, wherein when transmitting notification information includes transmitting approval request information for requesting approval of notifying the information about the item to an acknowledger through a network when it is determined that the received amount of exercise has reached the target level, and
transmitting the notification information when the acknowledger receives approval information that indicates that the acknowledger has approved in response to the approval request information.

20. A non-transitory computer-readable recording medium storing an exercise management program causing a computer to perform a method, the method comprising:
storing information for identifying an item selected by a user and a target level of an amount of exercise determined by the user, in a storage unit;
receiving the amount of exercise measured according to exercise by the user;
determining whether the received amount of exercise has reached the target level stored in the storage unit; and
transmitting notification information including information about the item stored in the storage unit to the user through a network when it is determined that the received amount of exercise has reached the target level.
